(19) United States
(12) Patent Application Publication
(10) Pub. No.: US 2019/0009784 A1
(43) Pub. Date: Jan. 10, 2019

(54) VEHICLE CONTROL APPARATUS, VEHICLE CONTROL METHOD, AND VEHICLE CONTROL PROGRAM

(71) Applicant: HONDA MOTOR CO., LTD., Minato-ku, Tokyo (JP)

(72) Inventor: Masanori Takeda, Tokyo (JP)

(21) Appl. No.: 15/748,770

(22) PCT Filed: Jul. 14, 2016
(86) PCT No.: PCT/JP2016/070857

§ 371 Date: Jan. 30, 2018

(30) Foreign Application Priority Data
Aug. 6, 2015 (JP) 2015-156207
Sep. 11, 2015 (JP) 2015-179974

(51) Int. Cl. B60W 30/18; G08G 1/16

(52) U.S. Cl. CPC B60W 30/18163; B60W 2550/308; B60W 2550/304; G08G 1/167

(57) ABSTRACT

A vehicle control apparatus includes: an estimation part that estimates a lane change by a peripheral vehicle which is traveling around a vehicle; a virtual vehicle-setting part that sets a virtual vehicle, which virtually simulates the peripheral vehicle as a target of the estimation, on a lane of a lane change destination of the peripheral vehicle when the lane change of the peripheral vehicle is estimated by the estimation part; a control plan generation part that generates a control plan of the vehicle based on the virtual vehicle which is set by the virtual vehicle-setting part; and a travel control part that controls acceleration, deceleration, or steering of the vehicle based on the control plan which is generated by the control plan generation part.

### TECHNICAL FIELD

The present invention relates to a vehicle control apparatus, a vehicle control method, and a vehicle control program.

Priority is claimed on Japanese Patent Application No. 2015-156207, filed on Aug. 6, 2015, and Japanese Patent Application No. 2015-179974, filed on Sep. 11, 2015, the contents of which are incorporated herein by reference.

### BACKGROUND

Recently, techniques are desired in which a lane change while traveling is automatically performed depending on a relative relationship between a self-vehicle (hereinafter, also referred to as a first vehicle or simply a vehicle) and a peripheral vehicle.

In relation to this, a travel assist apparatus is known which includes: an assist start part that starts an assist of a lane change on the basis of an input of an input device; a detection part that detects a relative distance and a relative speed between a self-vehicle (hereinafter, also referred to as a first vehicle or simply a vehicle) and another vehicle (hereinafter, also referred to as a second vehicle or other vehicles); a calculation part that calculates a collision risk degree when the vehicle performs a lane change with respect to another vehicle on the basis of the relative distance and the relative speed that are detected by the detection part; a first determination part that determines whether or not it is possible to perform a lane change on the basis of the relative distance, the relative speed, and the collision risk degree; a determination part that determines a target space by which a lane change is performed on the basis of the relative distance and the relative speed when the first determination part determines that it is impossible to perform a lane change; a second determination part that determines whether or not there is a space by which a lane change can be performed in the target space; a setting part that sets a target speed toward a lane change waiting position when the second determination part determines that there is not the space and that sets a target speed toward a lane change available position when it is determined that there is the space; and a control part that controls the speed of the vehicle so as to be the target speed (for example, refer to Patent Document 1).

### RELATED ART DOCUMENTS

### Patent Documents

[Patent Document 1] Japanese Unexamined Patent Application, First Publication No. 2009-078735

### SUMMARY OF INVENTION

### Problems to be Solved by the Invention

However, in the related art, when controlling the travel of a vehicle on the basis of a detection result by a detection part such as a radar and a camera, there may be a case in which it is not possible to perform flexible automated driving in response to the movement of a peripheral vehicle.

In view of the foregoing, an object of an aspect of the present invention is to provide a vehicle control apparatus, a vehicle control method, and a vehicle control program capable of performing flexible automated driving in response to the movement of a peripheral vehicle.

### Means for Solving the Problem

(1) An aspect of the present invention is a vehicle control apparatus that is provided on a vehicle, the apparatus including: an estimation part that estimates a lane change by a peripheral vehicle which is traveling around the vehicle; a virtual vehicle-setting part that sets a virtual vehicle, which virtually simulates the peripheral vehicle as a target of the estimation, on a lane of a lane change destination of the peripheral vehicle when the lane change by the peripheral vehicle is estimated by the estimation part; a control plan generation part that generates a control plan of the vehicle based on the virtual vehicle which is set by the virtual vehicle-setting part; and a travel control part that controls acceleration, deceleration, or steering of the vehicle based on the control plan which is generated by the control plan generation part.

(2) In the above aspect (1), the virtual vehicle-setting part may set a state of the virtual vehicle based on information relating to a speed of the peripheral vehicle as the target of the estimation when the lane change by the peripheral vehicle is estimated by the estimation part.

(3) In the above aspect (1) or (2), the virtual vehicle-setting part may provide a non-setting region, in which the virtual vehicle is not set, at a frontward position from a position of the vehicle when the lane of the lane change destination of the peripheral vehicle when the lane change by the peripheral vehicle is estimated by the estimation part is a lane on which the vehicle is traveling.

(4) In the above aspect (3), the non-setting region may be provided based on a relative speed between a speed of the vehicle and a speed of the peripheral vehicle as the target of the estimation of the lane change.

(5) In any one of the above aspects (1) to (4), the virtual vehicle-setting part may set the virtual vehicle on a lane on which the vehicle is traveling when a lane change of the peripheral vehicle with respect to a space between the vehicle and a frontward traveling vehicle that is traveling at a frontward position of the vehicle is estimated by the estimation part, and the control plan generation part may generate the control plan of the vehicle based on the virtual vehicle which is set by the virtual vehicle-setting part in place of the frontward traveling vehicle.

(6) In any one of the above aspects (1) to (5), the estimation part may estimate that the peripheral vehicle which is traveling around the vehicle performs a lane change when detecting a decrease of the number of lanes at a frontward position of the vehicle.

(7) In the above aspect (6), the estimation part may detect a decrease of the number of lanes at a frontward position of the vehicle with reference to map information by using a position of the vehicle.

(8) In the above aspect (6) or (7), the estimation part may estimate a timing when the peripheral vehicle which is traveling around the vehicle performs a lane change based on a distance or an arrival time to a point where the number of lanes is decreased from the vehicle or the peripheral vehicle when detecting a decrease of the number of lanes at a frontward position of the vehicle.

(9) Another aspect of the present invention is a vehicle control apparatus that is provided on a vehicle, the apparatus including: an estimation part that estimates a lane change by a peripheral vehicle which is traveling around the vehicle when detecting a decrease of the number of lanes at a frontward position of the vehicle; a virtual vehicle-setting part that sets a virtual vehicle, which virtually simulates the peripheral vehicle as a target of the estimation, on a lane of a lane change destination of the peripheral vehicle when the lane change by the peripheral vehicle is estimated by the estimation part; and a travel control part that controls acceleration, deceleration, or steering of the vehicle based on the virtual vehicle which is set by the virtual vehicle-setting part.

(10) Still another aspect of the present invention is a vehicle control method, by way of a computer that is provided on a vehicle, including: estimating a lane change by a peripheral vehicle which is traveling around the vehicle; setting a virtual vehicle, which virtually simulates the peripheral vehicle as a target of the estimation, on a lane of a lane change destination of the peripheral vehicle when the lane change by the peripheral vehicle is estimated; generating a control plan of the vehicle based on the set virtual vehicle; and controlling acceleration, deceleration, or steering of the vehicle based on the generated control plan.

(11) Still another aspect of the present invention is a vehicle control program which causes a computer that is provided on a vehicle to: estimate a lane change by a peripheral vehicle which is traveling around the vehicle; set a virtual vehicle, which virtually simulates the peripheral vehicle as a target of the estimation, on a lane of a lane change destination of the peripheral vehicle when the lane change by the peripheral vehicle is estimated; generate a control plan of the vehicle based on the set virtual vehicle; and control acceleration, deceleration, or steering of the vehicle based on the generated control plan.

### Advantage of the Invention

According to the aspects (1), (2), (10), and (11) described above, when it is estimated that a peripheral vehicle which is traveling around a vehicle will perform a lane change, a virtual vehicle which virtually simulates the peripheral vehicle is set on a lane of a lane change destination of the peripheral vehicle; a control plan of the vehicle is generated on the basis of the set virtual vehicle; and acceleration, deceleration, or steering of the vehicle is controlled on the basis of the control plan, and therefore, it is possible to perform flexible automated driving in response to the movement of the peripheral vehicle.

According to the aspect (3) described above, when the lane of the lane change destination of the peripheral vehicle is a lane on which the vehicle is traveling, a non-setting region in which the virtual vehicle is not set is provided at a frontward position from a position of the vehicle, and therefore, it is possible to realize a gradual transition of a control state under a control of automated driving.

According to the aspect (4) described above, the non-setting region in which the virtual vehicle is not set is provided on the basis of a relative speed between the speed of the vehicle and the speed of the peripheral vehicle as the target of the estimation, and therefore, it is possible to perform further flexible automated driving in response to the movement of the peripheral vehicle.

According to the aspect (5) described above, when a lane change with respect to a space between the vehicle and a frontward traveling vehicle that is traveling at a frontward position of the vehicle is estimated, the virtual vehicle is set on a lane on which the vehicle is traveling; and the control plan of the vehicle is generated on the basis of the virtual vehicle which is set in place of the frontward traveling vehicle, and therefore, it is possible to perform further flexible automated driving in response to the movement of the peripheral vehicle.

According to the aspects (6) and (7) described above, when a decrease of the number of lanes at a frontward position of the vehicle is detected, it is estimated that the peripheral vehicle which is traveling around the vehicle will perform a lane change, and therefore, it is possible to perform more speedy and accurate estimation than a case in which the lane change of the peripheral vehicle is estimated by only information that is obtained from the peripheral vehicle.

According to the aspect (8) described above, when a decrease of the number of lanes at a frontward position of the vehicle is detected, a timing when the peripheral vehicle which is traveling around the vehicle performs a lane change is estimated on the basis of a distance or an arrival time to a point where the number of lanes is decreased, and therefore, it is possible to perform further accurate estimation.

According to the aspect (9) described above, when it is estimated that a peripheral vehicle which is traveling around a vehicle will perform a lane change, a virtual vehicle which virtually simulates the peripheral vehicle is set on a lane of a lane change destination of the peripheral vehicle; and acceleration, deceleration, or steering of the vehicle is controlled on the basis of the set virtual vehicle, and therefore, it is possible to perform a further safe control in response to the movement of the peripheral vehicle.

### BRIEF DESCRIPTION OF THE DRAWINGS

FIG. 1 is a view showing a configuration element included in a vehicle on which a vehicle control apparatus according to a first embodiment is provided.

FIG. 2 is a function configuration view of a vehicle focusing on the vehicle control apparatus according to the first embodiment.

FIG. 3 is a view showing a state in which a relative position of a vehicle with respect to a travel lane is recognized by a vehicle position recognition unit 102.

FIG. 4 is a view showing a state in which a lane change of a peripheral vehicle is estimated when a lane number decrease is detected by an outside recognition unit.

FIG. 5 is a view showing an example of an action plan that is generated with respect to a zone.

FIG. 6 is a view showing a state in which a target position candidate-setting part in the first embodiment sets a lane change target position candidate.

FIG. 7 is a flowchart showing an example of a process flow of a lane change control part in the first embodiment.

FIG. 8 is a flowchart (part 1) showing an example of a flow of a setting process of a virtual vehicle in the first embodiment.

FIG. 9 is a flowchart (part 2) showing an example of the flow of the setting process of the virtual vehicle in the first embodiment.

FIG. 10 is a view showing an example of a scene in which a frontward traveling vehicle is not recognized in a detection region.

FIG. 11 is a view showing an example of a state in which the virtual vehicle is set in the vicinity of an outer edge of the detection region.

FIG. 12 is a view showing another example of the state in which the virtual vehicle is set in the vicinity of the outer edge of the detection region.

FIG. 13 is a view showing an example of a scene in which a lane-change target-position candidate rearward-traveling vehicle is not recognized in the detection region.

FIG. 14 is a view showing an example of a scene in which a virtual interrupt vehicle which virtually simulates the lane-change target-position candidate rearward-traveling vehicle is set.

FIG. 15 is a view showing an example of a scene in which the virtual interrupt vehicle which virtually simulates the lane-change target-position candidate rearward-traveling vehicle is not set.

FIG. 16 is a view showing an example of a scene in which a lane-change target-position candidate frontward-traveling vehicle is not recognized in the detection region.

FIG. 17 is a view showing an example of a scene in which a virtual interrupt vehicle which virtually simulates the lane-change target-position candidate frontward-traveling vehicle is set.

FIG. 18 is a view showing an example of a scene in which the virtual interrupt vehicle which virtually simulates the lane-change target-position candidate frontward-traveling vehicle is not set.

FIG. 19 is a view showing another example of a scene in which a virtual interrupt vehicle which virtually simulates the lane-change target-position candidate rearward-traveling vehicle is set.

FIG. 20 is a view showing an example of a scene in which a virtual interrupt vehicle which virtually simulates a second adjacent lane-traveling vehicle is set.

FIG. 21 is a view showing another example of a scene in which the virtual interrupt vehicle which virtually simulates the second adjacent lane-traveling vehicle is set.

FIG. 22 is a view showing an example of, in a case where a peripheral vehicle that becomes a determination target is recognized, a positional relationship between the vehicle and the peripheral vehicle.

FIG. 23 is a view showing patterns into which the position change of the peripheral vehicle is categorized with respect to Pattern (a) of the vehicle positional relationship.

FIG. 24 is a view showing patterns into which the position change of the peripheral vehicle is categorized with respect to Pattern (b) of the vehicle positional relationship.

FIG. 25 is a view showing an example of, in a case where part of a monitored vehicle is not recognized, a positional relationship between the vehicle and the monitored vehicle.

FIG. 26 is a view showing patterns into which the position change of the peripheral vehicle is categorized with respect to Pattern (c) of the vehicle positional relationship.

FIG. 27 is a view showing an example of a control plan used for a lane change that is generated by a control plan generation part.

FIG. 28 is a flowchart (part 1) showing an example of a process flow of a lane change control unit in a second embodiment.

FIG. 29 is a flowchart (part 2) showing an example of the process flow of the lane change control unit in the second embodiment.

FIG. 30 is a view schematically representing whether or not a non-setting region is set.

FIG. 31 is a view showing an example of a relationship between a distance component of a lane length direction in the non-setting region and a relative speed.

FIG. 32 is a view schematically showing a scene in which a virtual interrupt vehicle which virtually simulates a lane-change target-position candidate frontward-traveling vehicle is set in a detection region at a frontward position of the non-setting region.

FIG. 33 is a function configuration view of a vehicle focusing on a vehicle control apparatus according to a third embodiment.

### DESCRIPTION OF THE EMBODIMENTS

Hereinafter, a vehicle control apparatus, a vehicle control method, and a vehicle control program according to embodiments of the present invention are described with reference to the drawings.

### First Embodiment

[Vehicle Configuration]

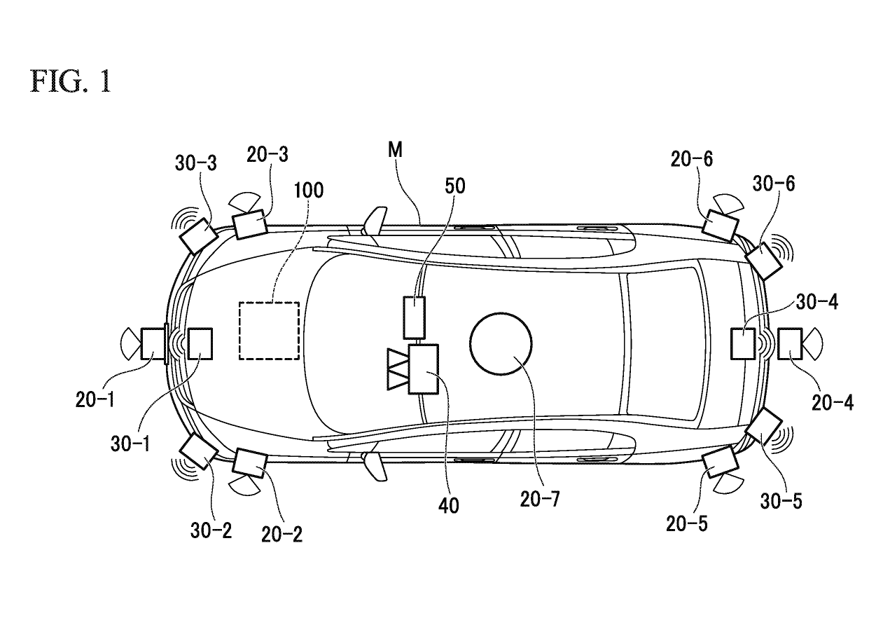

FIG. 1 is a view showing a configuration element included in a vehicle M (hereinafter, also referred to as a first vehicle M) on which a vehicle control apparatus 100 according to a first embodiment is mounted. A vehicle on which the vehicle control apparatus 100 is mounted is, for example, an automobile having two wheels, three wheels, four wheels, and the like and includes an automobile using an internal combustion engine such as a diesel engine or a gasoline engine as a power source, an electric automobile using an electric motor as a power source, a hybrid automobile including both an internal combustion engine and an electric motor, and the like. The above-described electric automobile is driven, for example, by using electric power that is discharged by a battery such as a secondary battery, a hydrogen fuel cell, a metallic fuel cell, and an alcohol fuel cell.

As shown in FIG. 1, the vehicle M includes: a sensor such as finders 20-1 to 20-7, radars 30-1 to 30-6, and a camera 40; a navigation device 50; and the vehicle control apparatus 100. The finders 20-1 to 20-7 are, for example, LIDARs (Light Detection and Ranging, or Laser Imaging Detection and Ranging) that measure scattered light with respect to irradiation light to measure a distance to a target. For example, the finder 20-1 is attached to a front grille or the like, and the finders 20-2 and 20-3 are attached to a side surface of a vehicle body, a door mirror, the inside of a head lamp, the vicinity of a side lamp, or the like. The finder 20-4 is attached to a trunk lid or the like, and the finders 20-5 and 20-6 are attached to a side surface of the vehicle body, the inside of a tail lamp, or the like. The finders 20-1 to 20-6 have, for example, a detection region of about 150 degrees regarding a horizontal direction. The finder 20-7 is attached to a roof or the like. The finder 20-7 has, for example, a detection region of 360 degrees regarding the horizontal direction.

The radars 30-1 and 30-4 are, for example, long-distance millimeter-wave radars having a wider detection range in a depth direction than that of other radars. The radars 30-2, 30-3, 30-5, and 30-6 are middle-distance millimeter-wave radars having a narrower detection range in the depth direction than that of the radars 30-1 and 30-4. Hereinafter, when the finders 20-1 to 20-7 are not specifically distinguished, the finders 20-1 to 20-7 are simply referred to as “a finder 20”, and when the radars 30-1 to 30-6 are not specifically distinguished, the radars 30-1 to 30-6 are simply referred to as “a radar 30”. The radar 30 detects an object, for example, using a FM-CW (Frequency-Modulated Continuous Wave) method.

The camera 40 is, for example, a digital camera that utilizes a solid-state imaging element such as a CCD (Charge-Coupled Device) or a CMOS (Complementary Metal Oxide Semiconductor). The camera 40 is attached to an upper part of a front window shield, a rear surface of a room mirror, or the like. The camera 40 periodically and repeatedly captures, for example, an image of the frontward direction of the vehicle M.

The configuration shown in FIG. 1 is merely an example; and part of the configuration may be omitted, or another configuration may be further added.

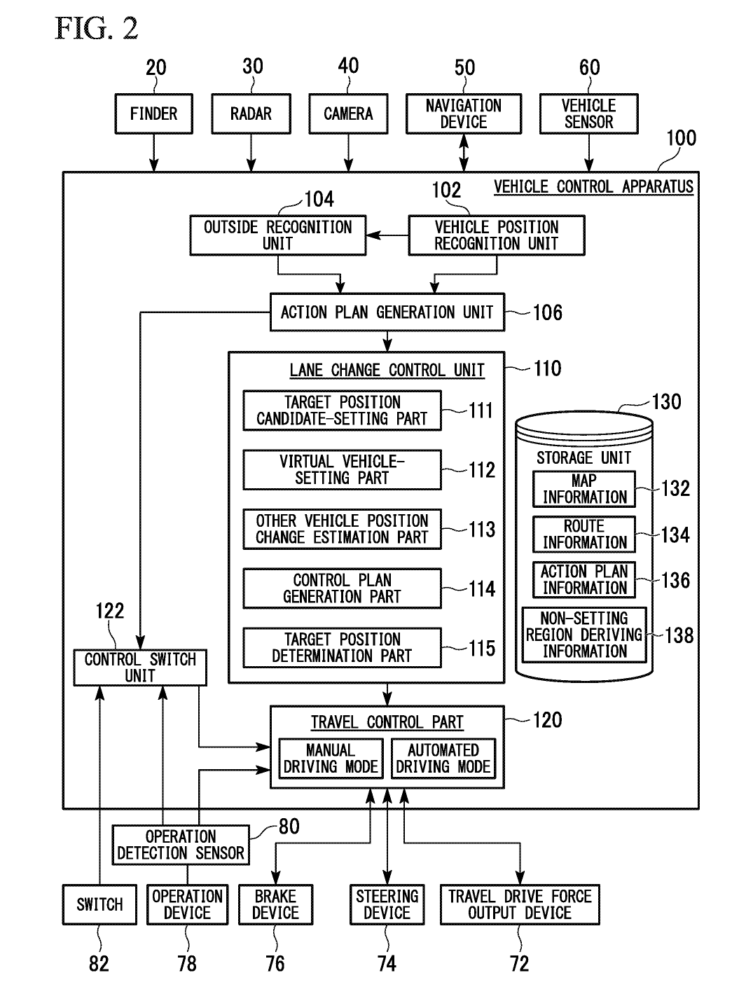

FIG. 2 is a function configuration view of the vehicle M focusing on the vehicle control apparatus 100 according to the first embodiment. The vehicle M includes the navigation device 50, a vehicle sensor 60, a travel drive force output device 72, a steering device 74, a brake device 76, an operation device 78, an operation detection sensor 80, a switch 82, and the vehicle control apparatus 100 in addition to the finder 20, the radar 30, and the camera 40. These devices and equipment are mutually connected by a multiplex communication line such as a CAN (Controller Area Network) communication line, a serial communication line, a wireless communication network, or the like.

The navigation device 50 has a GNSS (Global Navigation Satellite System) receiver, map information (navigation map), a touch-panel display device that functions as a user interface, a speaker, a microphone, and the like. The navigation device 50 identifies the position of the vehicle M using the GNSS receiver and derives a route to a destination that is assigned by a user from the position. The route derived by the navigation device 50 is stored in a storage part 130 as route information 134. The position of the vehicle M may be identified or supplemented by an INS (Inertial Navigation System) that utilizes the output of the vehicle sensor 60. The navigation device 50 performs a guide with respect to the route to the destination by speech or a navigation display when the vehicle control apparatus 100 is performing a manual driving mode. The configuration that identifies the position of the vehicle M may be provided independently from the navigation device 50. The navigation device 50 may be realized by, for example, a function of a terminal apparatus such as a smartphone or a tablet terminal held by a user. In this case, transmission and reception of information are performed using a radio frequency or by a communication between the terminal apparatus and the vehicle control apparatus 100. The configuration that identifies the position of the vehicle M may be provided independently from the navigation device 50.

The vehicle sensor 60 includes: a vehicle speed sensor that detects a vehicle speed; an acceleration sensor that detects acceleration; a yaw rate sensor that detects an angular speed around a vertical axis; an azimuth sensor that detects the direction of the vehicle M; and the like.

The travel drive force output device 72 includes an engine and an engine ECU (Electronic Control Unit) that controls the engine, for example, when the vehicle M is an automobile using an internal combustion engine as a power source. The travel drive force output device 72 includes a travel motor and a motor ECU that controls the travel motor, for example, when the vehicle M is an electric automobile using an electric motor as a power source. The travel drive force output device 72 includes an engine, an engine ECU, a travel motor, and a motor ECU, for example, when the vehicle M is a hybrid automobile. When the travel drive force output device 72 includes only an engine, the engine ECU adjusts the throttle opening degree of the engine, a shift step, and the like and outputs a travel drive force (torque) by which the vehicle travels in accordance with information that is input from a travel control part 120 described below. When the travel drive force output device 72 includes only a travel motor, the motor ECU adjusts the duty ratio of a PWM signal that is given to the travel motor and outputs the travel drive force described above in accordance with information that is input from the travel control part 120. When the travel drive force output device 72 includes an engine and a travel motor, both of the engine ECU and the motor ECU control a travel drive force in a mutually coordinated manner in accordance with information that is input from the travel control part 120.

The steering device 74 includes, for example, an electric motor, a steering torque sensor, a steering angle sensor, and the like. For example, the electric motor applies a force to a rack-and-pinion function and the like and changes the direction of a steering wheel. The steering torque sensor detects the torsion of a torsion bar, for example, when the steering wheel is operated, as a steering torque (steering force). The steering angle sensor detects, for example, a steering angle (or actual steering angle). The steering device 74 drives the electric motor and changes the direction of the steering wheel in accordance with information that is input from the travel control part 120.

The brake device 76 includes: a master cylinder in which a brake operation applied to a brake pedal is transmitted as an oil pressure; a reservoir tank that reserves a brake fluid; a brake actuator that adjusts a brake force which is output to each wheel; and the like. A brake control part 44 controls a brake actuator and the like such that a brake torque which corresponds to the pressure of the master cylinder is output to each wheel in accordance with information that is input from the travel control part 120. The brake device 76 is not limited to the above-described electronically-controlled brake device which is operated by the oil pressure and may be an electronically-controlled brake device which is operated by an electric actuator.

The operation device 78 includes, for example, an accelerator pedal, a steering wheel, a brake pedal, a shift lever, and the like. An operation detection sensor 80 that detects the presence or absence of an operation by a driver and the amount of the operation is attached to the operation device 78. The operation detection sensor 80 includes, for example, an accelerator opening degree sensor, a steering torque sensor, a brake sensor, a shift position sensor, and the like. The operation detection sensor 80 outputs an accelerator opening degree, a steering torque, a brake press amount, a shift position, and the like as a detection result to the travel control part 120. Alternatively, the detection result of the operation detection sensor 80 may be output directly to the travel drive force output device 72, the steering device 74, or the brake device 76.

The switch 82 is a switch that is operated by a driver and the like. The switch 82 may be, for example, a mechanical switch that is arranged on the steering wheel, a garnish (dashboard), and the like or may be a GUI (Graphical User Interface) switch that is provided on a touch panel of the navigation device 50. The switch 82 accepts an operation of the driver and the like, generates a control mode designation signal that designates the operation mode by the travel control part 120 to any one of an automated driving mode and a manual driving mode, and outputs the control mode designation signal to a control switch unit 122. The automated driving mode is a driving mode in which the vehicle travels in a state where the driver does not perform an operation (alternatively, the operation amount is smaller than that of the manual driving mode, or the operation frequency is low) as described above. More specifically, the automated driving mode is a driving mode in which part of or all of the travel drive force output device 72, the steering device 74, and the brake device 76 are controlled on the basis of an action plan.

[Vehicle Control Apparatus]

Hereinafter, the vehicle control apparatus 100 is described. The vehicle control apparatus 100 includes, for example, a vehicle position recognition unit 102, an outside recognition unit 104, an action plan generation unit 106, a lane change control unit 110, a travel control unit 120, the control switch unit 122, and a storage unit 130. Part of or all of the vehicle position recognition unit 102, the outside recognition unit 104, the action plan generation unit 106, the lane change control unit 110, the travel control unit 120, and the control switch unit 122 are software function units that functions by executing a program by a processor such as a CPU (Central Processing Unit). Part of or all of the units may be hardware function units such as a LSI (Large-Scale Integration) and an ASIC (Application-Specific Integrated Circuit). The storage unit 130 is implemented by a ROM (Read-Only Memory), a RAM (Random-Access Memory), a HDD (Hard Disk Drive), a flash memory, and the like. The program executed by the processor may be stored in the storage unit 130 in advance or may be downloaded from an external device via an in-vehicle Internet system and the like. The program executed by the processor may be installed in the storage unit 130 by mounting a portable storage medium that stores the program on a drive device (not shown).

The vehicle position recognition unit 102 recognizes the lane (travel lane) on which the vehicle M is travelling and the relative position of the vehicle M with respect to the travel lane on the basis of map information 132 that is stored in the storage unit 130 and information that is input from the finder 20, the radar 30, the camera 40, the navigation device 50, or the vehicle sensor 60. The map information 132 is, for example, map information having higher accuracy than a navigation map that is included in the navigation device 50. The map information 132 includes information of the center of a lane, information of the boundary of a lane, or the like. More specifically, the map information 132 includes road information, traffic regulation information, address information (address and zip code), facility information, phone number information, and the like. The road information includes information showing the class of a road such as a freeway, a toll road, a national road, or a prefectural road and information of the lane number of a road, the width of each lane, the gradient of a road, the position of a road (three-dimensional coordinate including the longitude, latitude, and height), the curvature of a curve of a lane, the position of merging and branching points of a lane, a sign provided on a road, and the like. The traffic regulation information includes information of the closure of a lane due to a work, a traffic accident, a traffic jam, and the like.

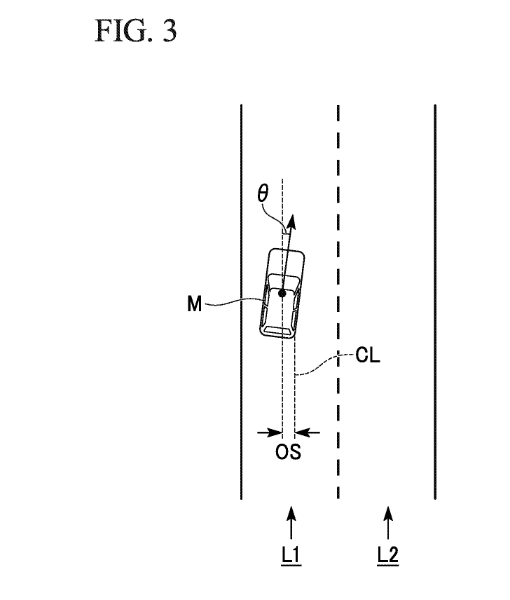

FIG. 3 is a view showing a state in which the relative position of the vehicle M with respect to a travel lane L1 is recognized by the vehicle position recognition unit 102. For example, the vehicle position recognition unit 102 recognizes, as the relative position of the vehicle M with respect to the travel lane L1, a gap OS of a reference point (for example, the center of gravity) of the vehicle M from a travel lane center CL and an angle θ that is formed of the proceeding direction of the vehicle M and a line formed by connecting the travel lane centers CL. Alternatively, the vehicle position recognition unit 102 may recognize, as the relative position of the vehicle M with respect to the travel lane, the position of the reference point of the vehicle M with respect to any of side end parts of the travel lane L1 (the lane on which the vehicle M travels) and the like.

The outside recognition unit 104 recognizes the state of the position, speed, acceleration, and the like of a peripheral vehicle on the basis of information that is input from the finder 20, the radar 30, the camera 40, and the like. The peripheral vehicle in the present embodiment is a vehicle that is traveling in the vicinity of the vehicle M and is a vehicle that is traveling in the same direction as the vehicle M. The position of a peripheral vehicle may be represented by a representative point such as the center of gravity or a corner of another vehicle (hereinafter, also referred to as a second vehicle) or may be represented by a region described by the outline of another vehicle. The “state” of a peripheral vehicle may include the acceleration of the peripheral vehicle and whether or not the peripheral vehicle is changing a lane (or whether or not the peripheral vehicle will change a lane) on the basis of the information of the devices described above. The outside recognition unit 104 may recognize positions of a guardrail, a power pole, a parked vehicle, a pedestrian, and other objects in addition to a peripheral vehicle.

The outside recognition unit 104 estimates whether or not the peripheral vehicle is changing a lane (or whether or not the peripheral vehicle will change a lane) on the basis of the position history of the peripheral vehicle, the operation state of a direction indicator, and the like. When detecting a lane number decrease at a frontward position of the vehicle M on the basis of the position of the vehicle M and the map information 132 that are acquired from the navigation device 50 or information that is input from the finder 20, the radar 30, the camera 40, and the like, the outside recognition unit 104 estimates a lane change of the peripheral vehicle on the basis of the distance or the arrival time to the point of the lane number decrease. The outside recognition unit 104 is an example of an “estimation part”.

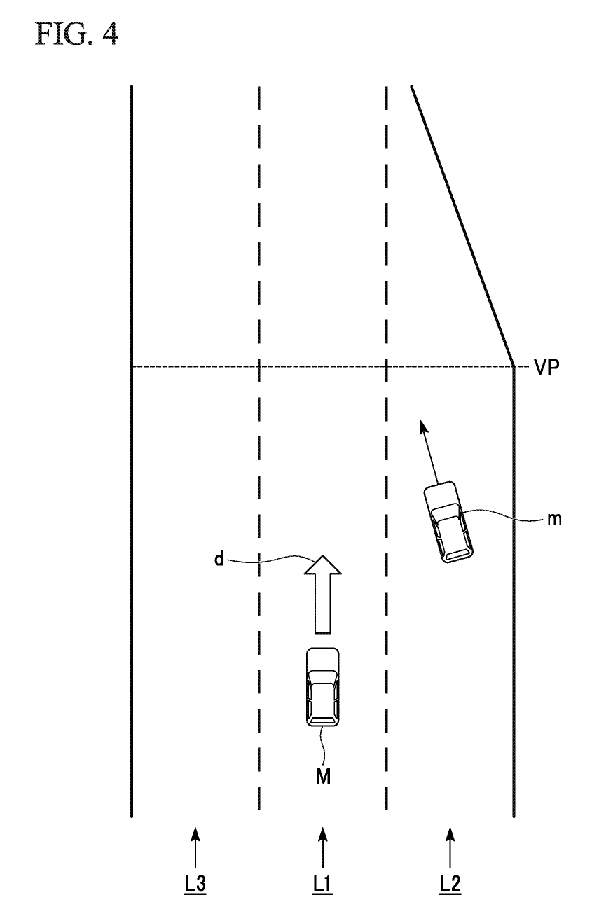

FIG. 4 is a view showing a state in which a lane change of a peripheral vehicle is estimated when a lane number decrease is detected by the outside recognition unit 104. In the drawing, “m” represents a peripheral vehicle, “d” represents a proceeding (travel) direction of each vehicle, “L1” represents a lane on which the vehicle M is traveling, and “L2”, “L3” represent an adjacent lane. As shown in the drawing, the road has a shape in which the adjacent lane L2 disappears and merges into the lane L1 at a point VP at a frontward position of the vehicle M. In this case, the outside recognition unit 104 estimates that the peripheral vehicle m that is traveling on the adjacent lane L2 performs a lane change to the lane L1.

The outside recognition unit 104 searches the map information 132 on the basis of the position of the vehicle M that is acquired from the navigation device 50 and determines whether or not the point VP at which the lane number is decreased is present, for example, within a first predetermined distance (for example, several hundred meters to several kilometers) toward the frontward direction from the position of the vehicle M. Then, when it is determined that the point VP at which the lane number is decreased is present, the outside recognition unit 104 outputs, to subsequent another function unit (lane change control unit 110 and the like), an estimation result that the peripheral vehicle m will perform a lane change at a timing when the distance or the arrival time (time obtained by dividing the distance by the speed of the vehicle M or the peripheral vehicle m) from the vehicle M or the peripheral vehicle m that is traveling on the disappearing lane to the point VP becomes a predetermined value or less. That is, the timing of the lane change is estimated based on the distance or the arrival time to the point VP from the vehicle M or the peripheral vehicle m that is traveling on the disappearing lane. When the predetermined value is a value with respect to the distance, the predetermined value is set, for example, to about several tens of meters. When the predetermined value is a value with respect to the arrival time, the predetermined value is set, for example, to about several seconds. The above numerical values are examples, and the predetermined value is not limited to the numerical values.

The outside recognition unit 104 may detect the decrease of the lane number at the frontward position of the vehicle M on the basis of an image in front of the vehicle M that is captured by the camera 40.

The action plan generation unit 106 generates an action plan in a predetermined zone. The predetermined zone is, for example, a zone, which includes a toll road such as an expressway, of the route that is derived by the navigation device 50. The predetermined zone is not limited thereto, and the action plan generation unit 106 may generate an action plan with respect to an arbitrary zone.

The action plan is constituted of, for example, a plurality of events that are sequentially performed. Examples of the events include a deceleration event that decelerates the vehicle M, an acceleration event that accelerates the vehicle M, a lane-keeping event that causes the vehicle M to travel so as not to be deviated from the travel lane, a lane change event that causes the vehicle to change the travel lane, an overtaking event that causes the vehicle M to overtake a frontward traveling vehicle, a branching event that causes the vehicle to change the lane to a desired lane at a branching point or causes the vehicle M to travel so as not to be deviated from the current travel lane, a merging event that causes the vehicle M to accelerate or decelerate at a lane merging point to change the travel lane, and the like. For example, when a junction (branching point) is present in a toll road (for example, an expressway or the like), it is necessary for the vehicle control apparatus 100 to change the lane or keep the lane such that the vehicle M proceeds to a target direction in an automated driving mode. Accordingly, when it is determined that a junction is present on the route with reference to the map information 132, the action plan generation unit 106 sets a lane change event that performs a lane change to a desired lane by which it is possible to proceed to the destination direction, at a position from the current position (coordinate) of the vehicle M to the position (coordinate) of the junction. The information that indicates the action plan which is generated by the action plan generation unit 106 is stored in the storage part 130 as action plan information 136.

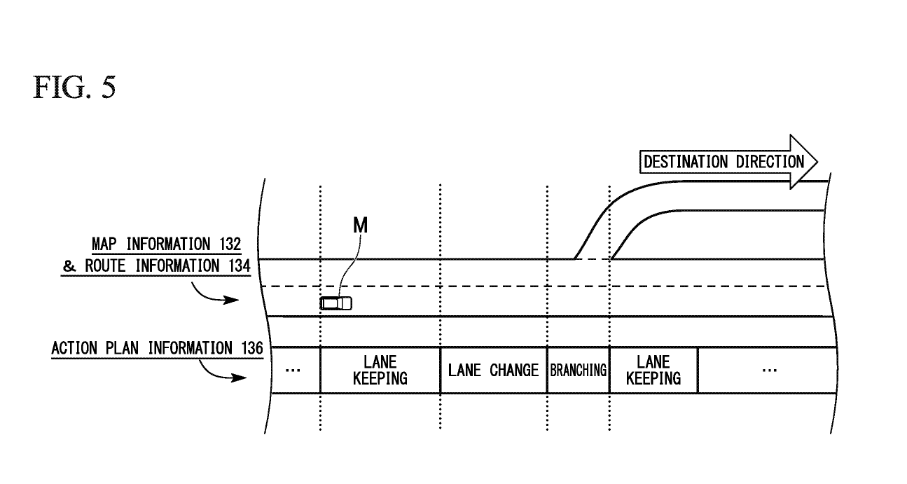

FIG. 5 is a view showing an example of an action plan that is generated with respect to a zone. As shown in the drawing, the action plan generation unit 106 categorizes situations that arise when traveling in accordance with the route to the destination and generates the action plan such that an event which is suitable for the individual situation is performed. The action plan generation unit 106 may change the action plan dynamically in response to the change in circumstances of the vehicle M.

The action plan generation unit 106 may change (update) the generated action plan, for example, on the basis of the state of the outside environment that is recognized by the outside recognition unit 104. In general, the state of the outside environment constantly changes while the vehicle is traveling. Specifically, when the vehicle M is traveling on a road that includes a plurality of lanes, the distance spacing with another vehicle is relatively changed. For example, when another frontward vehicle suddenly brakes to reduce the speed, or another vehicle that is traveling on an adjacent lane cuts into the space in front of the vehicle M, it is necessary for the vehicle M to travel while appropriately changing the speed or the lane in accordance with the behavior of another frontward vehicle or the behavior of another vehicle on the adjacent lane. Accordingly, the action plan generation unit 106 may change the event that is set for each control zone in response to the state change of the outside environment as described above.

Specifically, when the speed of another vehicle that is recognized by the outside recognition unit 104 while the vehicle is traveling exceeds a threshold value, or when the movement direction of another vehicle that is traveling on the adjacent lane which is adjacent to the travel lane is directed to the travel lane direction, the action plan generation unit 106 changes the event that is set for a drive zone in which the vehicle M is scheduled to travel. For example, in a case where the event is set such that a lane change event is performed after a lane-keeping event, when it is determined by the recognition result of the outside recognition unit 104 that, in the lane-keeping event, a vehicle is proceeding at a speed that is equal to or more than the threshold value from the rearward direction of a lane which is a lane change destination, the action plan generation unit 106 changes the next event of the lane-keeping event from the lane change to a deceleration event, a lane-keeping event, or the like. Thereby, the vehicle control apparatus 100 can prevent the vehicle M colliding with the vehicle at the lane change destination. As a result, the vehicle control apparatus 100 can allow the vehicle M to automatically travel safely even when the state of the outside environment is changed.

[Lane Change Event]

The lane change control unit 110 performs a control when a lane change event that is included in the action plan by the action plan generation unit 106 is performed. The lane change control unit 110 includes, for example, a target position candidate-setting part 111, a virtual vehicle-setting part 112, the other vehicle position change estimation part 113, a control plan generation part 114, and a target position determination part 115.

(Setting of Target Position Candidate)

The target position candidate-setting part 111 first sets the outline of a target region that becomes a lane change target with reference to the position of the peripheral vehicle that is recognized by the outside recognition unit 104 and sets, in the target region, a lane change target position candidate as a relative position with respect to a peripheral vehicle that is traveling on an adjacent lane which is adjacent to the travel lane (self-lane) on which the vehicle M is traveling. In the present embodiment, an example in which the target region corresponds to the entire detection region of a device is described. The target region may be a partial region of the detection region of the device.

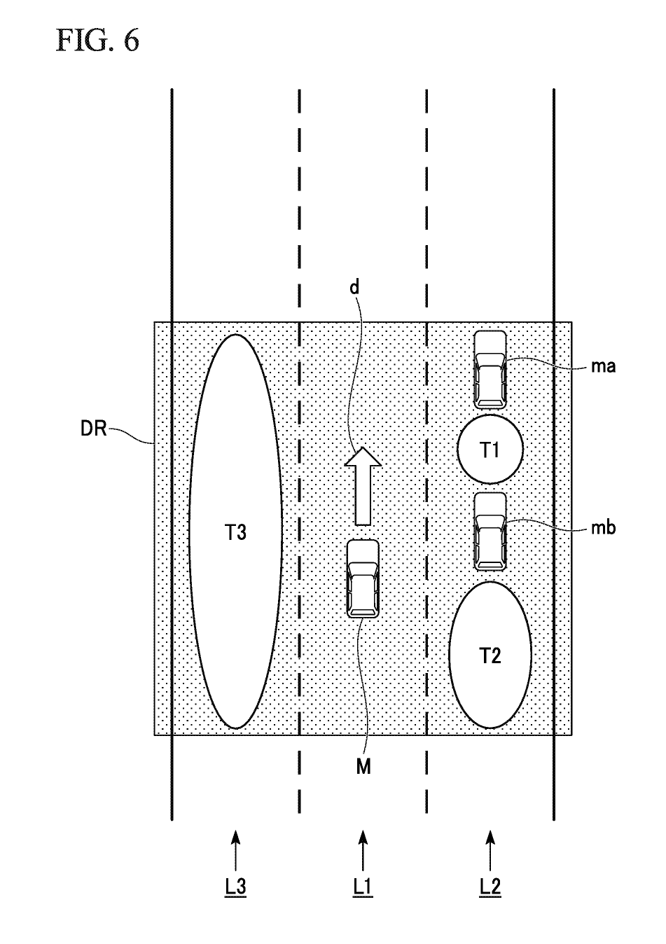

FIG. 6 is a view showing a state in which the target position candidate-setting part 111 in the first embodiment sets a lane change target position candidate. In FIG. 6, “ma”, “mb” represent a peripheral vehicle, “DR” represents a detection region, and “T1” to “T3” represent a lane change target position candidate When the lane change target position candidates are not specifically distinguished, the lane change target position candidates are represented simply as a lane change target position candidate T.

In the case of an example of FIG. 6, the target position candidate-setting part 111 sets the lane change target position candidate T1 between the vehicle ma and the vehicle mb on the adjacent lane L2 and sets the lane change target position candidate T2 at a space from a rearward position of the vehicle mb to an outer edge of the detection region DR on the rearward side with respect to the vehicle proceeding direction d. That is, when a plurality of peripheral vehicles are present on the adjacent lane, the target position candidate-setting part 111 sets the lane change target position candidate T between the peripheral vehicles. For example, when the number of the peripheral vehicles that are present is n, the number of the lane change target position candidates T that are set in the detection region DR on the adjacent lane by the target position candidate-setting part 111 is (n+1). In the example of FIG. 6, the frontward position of the vehicle ma is the boundary of the detection region D, and therefore, the target position candidate T cannot be set at the frontward position of the vehicle ma. Accordingly, two vehicles are present on the adjacent lane L2, and therefore, the target position candidate-setting part 111 needs to set three lane change target position candidates T; however, the target position candidate T cannot be set at the frontward position of the vehicle ma, and therefore, two lane change target position candidates T are set.

A peripheral vehicle is not present on the adjacent lane L3, and therefore, the target position candidate-setting part 111 sets the lane change target position candidate T3 at a space from a frontward outer edge of the detection region DR with respect to the vehicle proceeding direction d to a rearward outer edge of the detection region DR with respect to the vehicle proceeding direction d on the adjacent lane L3. That is, when a peripheral vehicle is not present on the adjacent lane, the target position candidate-setting part 111 sets one lane change target position candidate T in the entire detection region DR (in the entire adjacent lane L3) on the adjacent lane. In the following description, unless otherwise specified, it is assumed that it is commanded by the action plan to change the lane to the adjacent lane L2 that extends on the right side of the travel lane L1.

(Setting of Virtual Vehicle)

When a monitored vehicle is not recognized by the outside recognition unit 104, the virtual vehicle-setting part 112 sets a virtual vehicle which virtually simulates the monitored vehicle that is not recognized by the outside recognition unit 104 in a predetermined state at an outer edge of the detection region of the device.

The monitored vehicle includes a vehicle that is traveling at a frontward position of (immediately before) the vehicle M in the travel lane, a vehicle that is traveling at a frontward position of (immediately before) the lane change target position candidate T, and a vehicle that is traveling at a rearward position of (immediately after) the lane change target position candidate T. Hereinafter, a vehicle that is traveling at a frontward position of (immediately before) the vehicle M in the travel lane is referred to as a frontward traveling vehicle, a vehicle that is traveling at a frontward position of the lane change target position candidate T is referred to as a lane-change target-position candidate frontward-traveling vehicle, and a vehicle that is traveling at a rearward position of the lane change target position candidate T is referred to as a lane-change target-position candidate rearward-traveling vehicle.

The predetermined state includes a state in which the speed of the virtual vehicle is zero, a state in which the speed (or acceleration) of the virtual vehicle is equal to or less than a threshold value, and a state in which the speed of the virtual vehicle is the same as the speed of the vehicle M. For example, the virtual vehicle-setting part 112 may set a virtual vehicle that is stopping in the vicinity of the outer edge of the detection region or may set a virtual vehicle that is slowly traveling at a certain speed. In the present embodiment, the virtual vehicle-setting part 112 sets a virtual vehicle as a stationary body that is stopping when the virtual vehicle is set in the vicinity of the outer edge of the detection region on the frontward side of the vehicle M. In the present embodiment, the virtual vehicle-setting part 112 sets a virtual vehicle as a movable body having a predetermined speed (acceleration) when the virtual vehicle is set on the rearward side of the vehicle M or inside the detection region.

When the virtual vehicle is set as a movable body, the virtual vehicle-setting part 112 sets the virtual vehicle in a state in which the speed (or acceleration) of the virtual vehicle is equal to or more than a threshold value. For example, the virtual vehicle-setting part 112 may set a virtual vehicle that is traveling at a speed of constant number of times (including one time) of the maximum speed possible, in the vicinity of the outer edge of the detection region DR or may set a virtual vehicle that is traveling at a speed of constant times (including one time) of the speed of the vehicle M or the peripheral vehicle. The present embodiment is described using an example in which the virtual vehicle-setting part 112 sets the virtual vehicle as a movable body that is traveling at a possible maximum speed.

When a lane change of a monitored vehicle is estimated by the outside recognition unit 104, the virtual vehicle-setting part 112 sets a virtual vehicle which virtually simulates the monitored vehicle in a predetermined state on a lane of the lane change destination by the monitored vehicle. In the present embodiment, the lane change of the monitored vehicle is estimated by the outside recognition unit 104 in the detection region, and therefore, the virtual vehicle which virtually simulates the monitored vehicle that will change a lane or is changing a lane is set as a movable body.

In the following description, the virtual vehicle which virtually simulates the monitored vehicle that will change a lane or is changing a lane is specifically referred to as a virtual interrupt vehicle.

(Estimation of Position Change of Peripheral Vehicle)

The other vehicle position change estimation part 113 estimates a future position change with respect to the monitored vehicle (the frontward traveling vehicle, the lane-change target-position candidate frontward-traveling vehicle, and the lane-change target-position candidate rearward-traveling vehicle) that is recognized by the outside recognition unit 104. In this case, when any one or more vehicles of the frontward traveling vehicle, the lane-change target-position candidate frontward-traveling vehicle, and the lane-change target-position candidate rearward-traveling vehicle are not recognized by the outside recognition unit 104, the other vehicle position change estimation part 113 estimates a future position change with respect to the vehicle that is recognized by the outside recognition unit 104 of the three vehicles and the virtual vehicle that is set by the virtual vehicle-setting part 112 in response to a vehicle being unrecognized.

When a virtual interrupt vehicle is set by the virtual vehicle-setting part 112, the other vehicle position change estimation part 113 estimates a future position change with respect to part of or all of the monitored vehicle that is recognized by the outside recognition unit 104, the virtual vehicle that is set by the virtual vehicle-setting part 112 in response to a vehicle being unrecognized, and a virtual interrupt vehicle that is set by the virtual vehicle-setting part 112 in response to a vehicle performing a lane change operation.

The control plan generation part 114 generates a control plan for a lane change on the basis of the position change of the peripheral vehicle that is estimated by the other vehicle position change estimation part 113 for each lane change target position candidate T that is set by the target position candidate-setting part 111.

The target position determination part 115 determines one lane change target position T# from a plurality of lane change target position candidates T that are set by the target position candidate-setting part 111 on the basis of the control plan that is generated for each lane change target position candidate T by the control plan generation part 114.

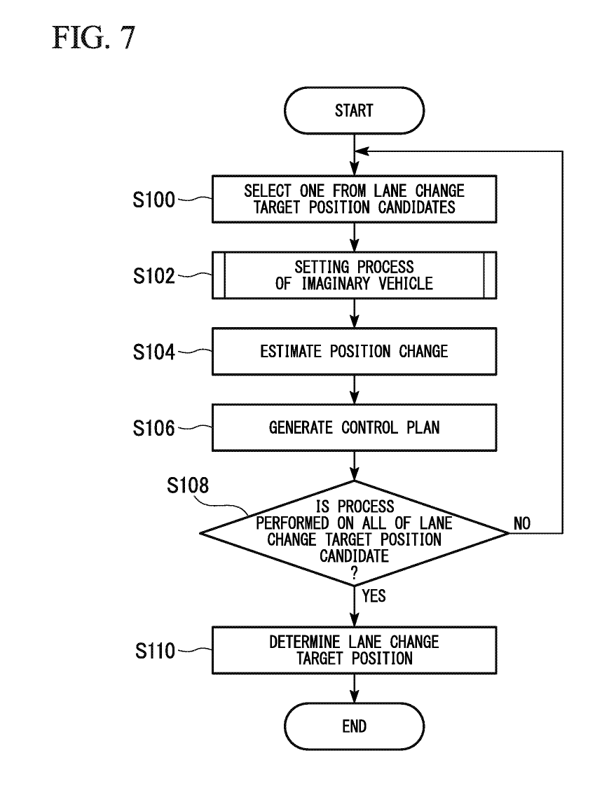

Hereinafter, a specific process of the lane change control unit 110 is described with reference to a flowchart. FIG. 7 is a flowchart showing an example of a process flow of the lane change control part 110 in the first embodiment.

First, the target position candidate-setting part 111 selects one from the lane change target position candidates T (Step S100). Next, the virtual vehicle-setting part 112 performs a setting process of a virtual vehicle (Step S102).

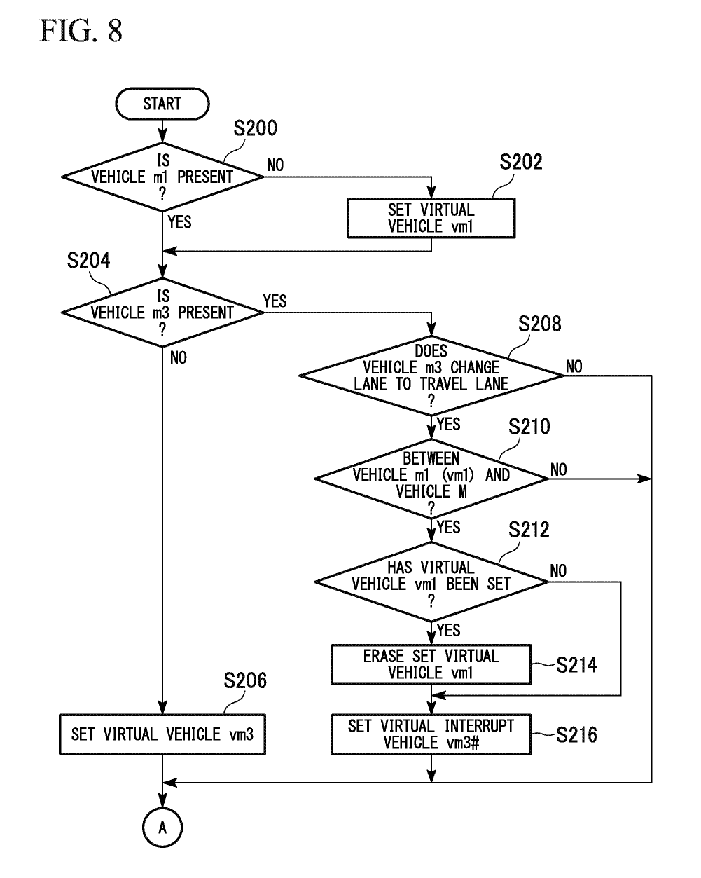

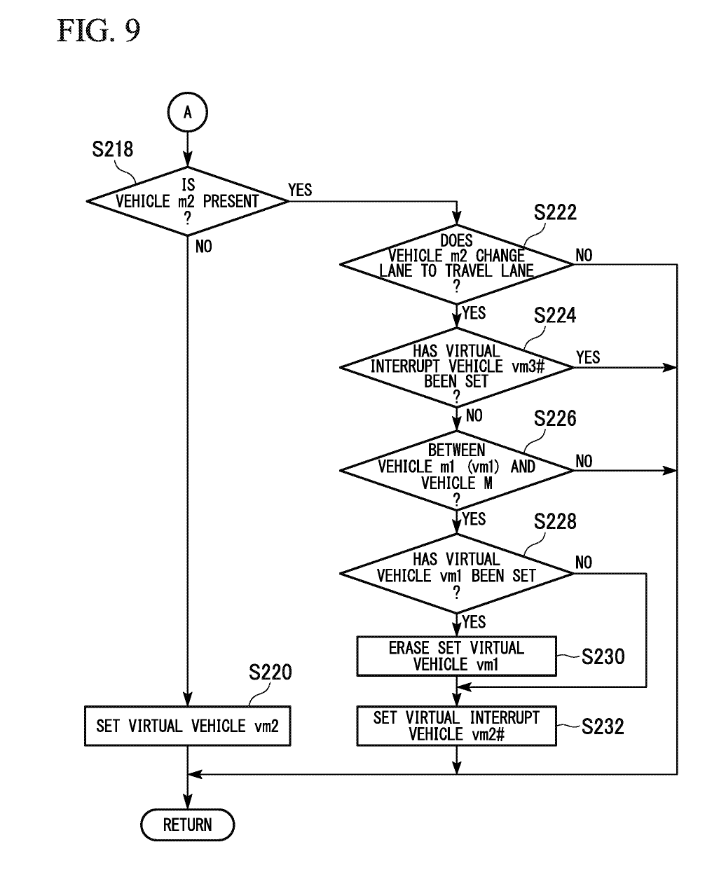

Hereinafter, a setting process of a virtual vehicle which is the process of Step S102 is described. FIG. 8 and FIG. 9 are flowcharts showing an example of the flow of the setting process of a virtual vehicle in the first embodiment. The process of the present flowchart corresponds to the process of Step S102 in the flowchart of FIG. 7 described above. In the following description, the frontward traveling vehicle is represented by “m1”, the lane-change target-position candidate frontward-traveling vehicle is represented by “m2”, and the lane-change target-position candidate rearward-traveling vehicle is represented by “m3”. A virtual vehicle that corresponds to the frontward traveling vehicle m1 is represented by “vm1”, a virtual vehicle that corresponds to the lane-change target-position candidate frontward-traveling vehicle m2 is represented by “vm2”, and a virtual vehicle that corresponds to the lane-change target-position candidate rearward-traveling vehicle m3 is represented by “vm3”. A virtual interrupt vehicle that corresponds to the lane-change target-position candidate frontward-traveling vehicle m2 during a lane change operation is represented by “vm2#”, and a virtual interrupt vehicle that corresponds to the lane-change target-position candidate rearward-traveling vehicle m3 during a lane change operation is represented by “vm3#”.

First, the virtual vehicle-setting part 112 determines whether or not a frontward traveling vehicle m1 is recognized by the outside recognition unit 104 (Step S200). When a frontward traveling vehicle m1 is not recognized by the outside recognition unit 104, the virtual vehicle-setting part 112 sets a virtual vehicle vm1 which virtually simulates a frontward traveling vehicle m1 as a stationary body in the vicinity of the outer edge of the detection region (Step S202).

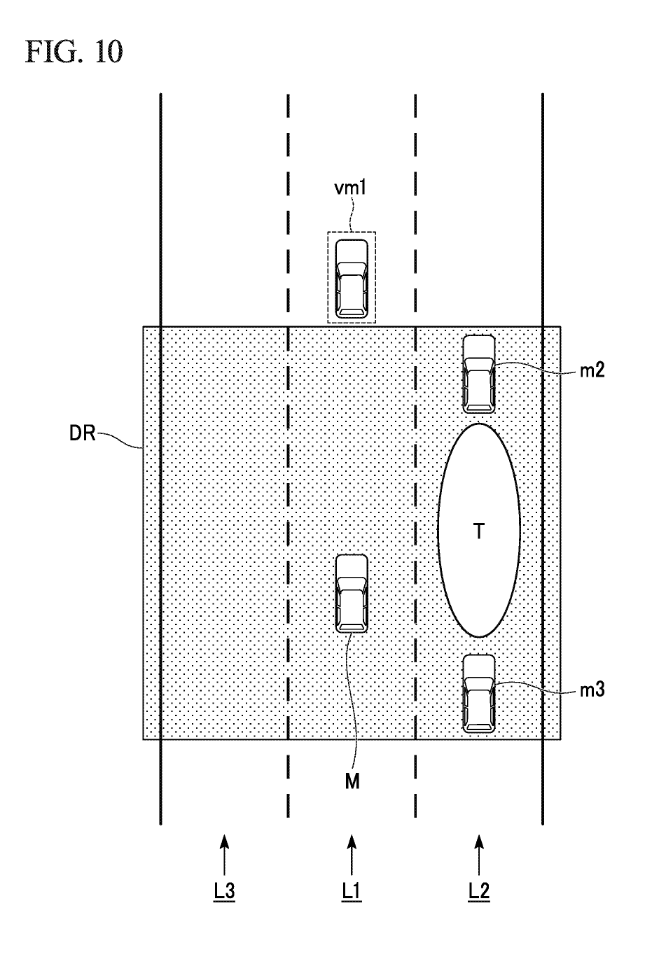

FIG. 10 is a view showing an example of a scene in which a frontward traveling vehicle m1 is not recognized in the detection region DR. In the example of FIG. 10, the travel lane (the lane on which the vehicle M is traveling) is represented by “L1”, the adjacent lane on the right side of the travel lane L1 is represented by “L2”, the adjacent lane on the left side of the travel lane L1 is represented by “L3”, and the lane change target position candidate is represented by “T”. In the example of FIG. 10, the vehicle m2 is located at a frontward position of the lane change target position candidate T in the adjacent lane L2 and is therefore recognized as the lane-change target-position candidate frontward-traveling vehicle. The vehicle m3 is located at a rearward position of the lane change target position candidate T in the adjacent lane L2 and is therefore recognized as the lane-change target-position candidate rearward-traveling vehicle. A vehicle that is located at a frontward position of the vehicle M in the travel lane L1 is not detected, and therefore, the frontward traveling vehicle m1 is not recognized. Accordingly, the virtual vehicle-setting part 112 sets a virtual vehicle vm1 of a stationary body in the vicinity of the outer edge of the detection region DR in the frontward direction of the travel lane L1.

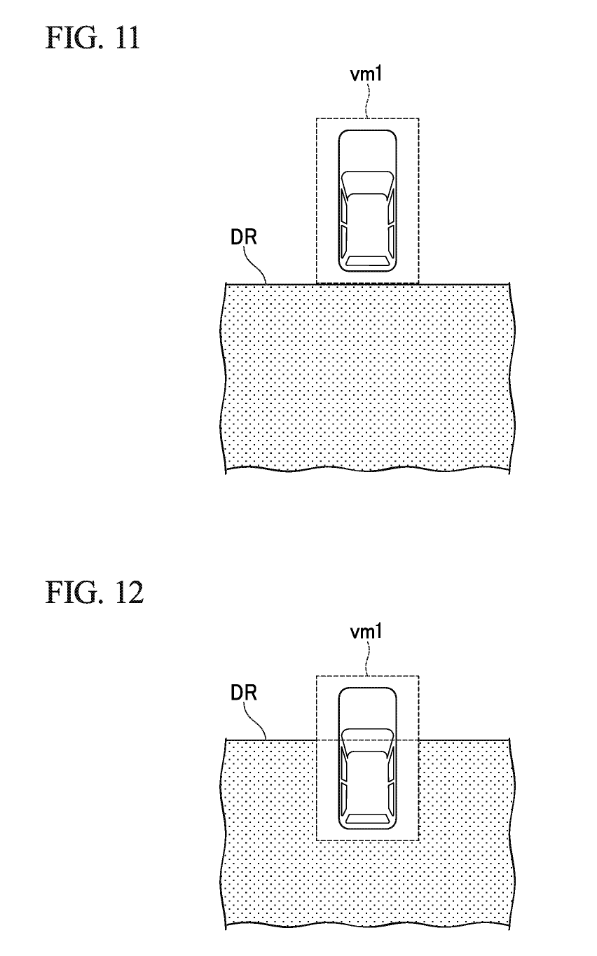

Specifically, the virtual vehicle-setting part 112 sets a virtual vehicle vm1 such that a rear end part of the vehicle body is located on the outside of the detection region DR. FIG. 11 is a view showing an example of a state in which the virtual vehicle vm1 is set in the vicinity of the outer edge of the detection region DR. As shown in FIG. 11, the virtual vehicle-setting part 112 arranges the virtual vehicle vm1 on the outside of the outer edge such that the entire vehicle body region is not included in the detection region DR.

The virtual vehicle-setting part 112 may set the virtual vehicle vm1 such that the rear end part of the vehicle body is located on the inside of the detection region DR. FIG. 12 is a view showing another example of the state in which the virtual vehicle vm1 is set in the vicinity of the outer edge of the detection region DR. As shown in FIG. 12, the virtual vehicle-setting part 112 arranges the virtual vehicle vm1 on the outer edge such that part of the vehicle body region is included in the detection region DR. The virtual vehicle-setting part 112 may arrange the virtual vehicle vm1 on the inside of the outer edge such that the entire vehicle body region is included in the detection region DR. The virtual vehicle-setting part 112 sets the virtual vehicle vm1, for example, at a center CL of the travel lane regarding the lane width direction with respect to the lane proceeding direction. The virtual vehicle-setting part 112 may set the virtual vehicle vm1 at a position that is away from the center CL regarding the lane width direction.

On the other hand, when the frontward traveling vehicle m1 is recognized by the outside recognition unit 104, or when the virtual vehicle vm1 is set, the virtual vehicle-setting part 112 determines whether or not the lane-change target-position candidate rearward-traveling vehicle m3 is recognized by the outside recognition unit 104 (Step S204). When the lane-change target-position candidate rearward-traveling vehicle m3 is not recognized by the outside recognition unit 104, the virtual vehicle-setting part 112 sets a virtual vehicle vm3 which virtually simulates the lane-change target-position candidate rearward-traveling vehicle m3 as a movable body in the vicinity of the outer edge of the detection region (Step S206).

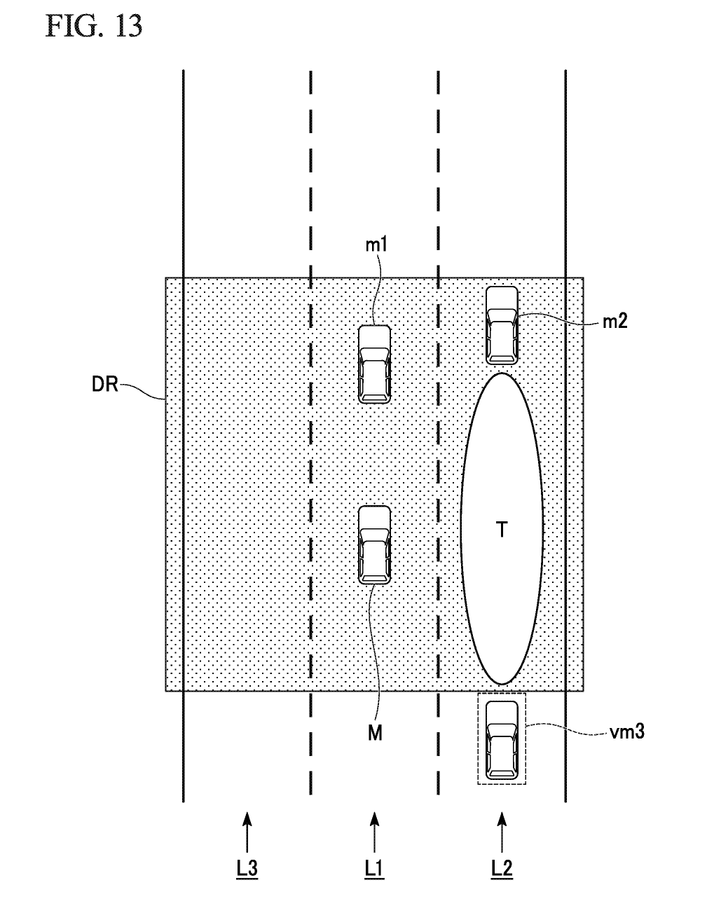

FIG. 13 is a view showing an example of a scene in which a lane-change target-position candidate rearward-traveling vehicle m3 is not recognized in the detection region DR. In the example of FIG. 13, similarly to FIG. 10, the travel lane is represented by “L1”, the adjacent lane on the right side of the travel lane L1 is represented by “L2”, the adjacent lane on the left side of the travel lane L1 is represented by “L3”, and the lane change target position candidate is represented by “T”. In the example of FIG. 13, the vehicle m1 is located at a frontward position of the vehicle M in the travel lane L1 and is therefore recognized as the frontward traveling vehicle. The vehicle m2 is located at a frontward position of the lane change target position candidate T in the adjacent lane L2 and is therefore recognized as the lane-change target-position candidate frontward-traveling vehicle. A vehicle that is located at a rearward position of the lane change target position candidate T in the adjacent lane L2 is not detected, and therefore, the lane-change target-position candidate rearward-traveling vehicle m3 is not recognized. Accordingly, the virtual vehicle-setting part 112 sets a virtual vehicle vm3 of a movable body in the vicinity of the outer edge of the detection region DR in the rearward direction of the adjacent lane L2.

The arrangement position of the virtual vehicle vm3 is similar to the arrangement position of the virtual vehicle vm1 described above. For example, the virtual vehicle-setting part 112 may set the virtual vehicle vm3 such that a front end part of the vehicle body is located on the outside of the detection region DR or may set the virtual vehicle vm3 such that a front end part of the vehicle body is located on the inside of the detection region DR.

On the other hand, when the lane-change target-position candidate rearward-traveling vehicle m3 is recognized by the outside recognition unit 104, the virtual vehicle-setting part 112 determines whether or not it is estimated that the lane-change target-position candidate rearward-traveling vehicle m3 that is recognized by the outside recognition unit 104 performs a lane change (or will perform a lane change) to the travel lane (Step S208).

When it is not estimated that the lane-change target-position candidate rearward-traveling vehicle m3 that is recognized by the outside recognition unit 104 performs a lane change (or will perform a lane change) to the travel lane, the virtual vehicle-setting part 112 performs a process of Step S218 described below. On the other hand, when it is estimated that the lane-change target-position candidate rearward-traveling vehicle m3 that is recognized by the outside recognition unit 104 performs a lane change (or will perform a lane change) to the travel lane, the virtual vehicle-setting part 112 determines whether or not the lane-change target-position candidate rearward-traveling vehicle m3 during a lane change operation is located at a more rearward position than the frontward traveling vehicle m1 or the virtual vehicle vm1 and at a more frontward position than the vehicle M, that is, whether or not the lane-change target-position candidate rearward-traveling vehicle m3 during a lane change operation is located at a position between the vehicle M and the frontward traveling vehicle m1 or the virtual vehicle vm1 (Step S210).

For example, when it is determined that the frontward traveling vehicle m1 is recognized by the outside recognition unit 104 in the determination process of Step S200, the virtual vehicle-setting part 112 compares the position of the lane-change target-position candidate rearward-traveling vehicle m3, the position of the frontward traveling vehicle m1, and the position of the vehicle M and determines whether or not the lane-change target-position candidate rearward-traveling vehicle m3 during a lane change operation is located at a position between the frontward traveling vehicle m1 and the vehicle M. More specifically, when a front end part of the lane-change target-position candidate rearward-traveling vehicle m3 is located at a more rearward position than a front end part of the frontward traveling vehicle m1 and is located at a more frontward position than a front end part of the vehicle M, the virtual vehicle-setting part 112 determines that the lane-change target-position candidate rearward-traveling vehicle m3 during a lane change operation is located at a position between the frontward traveling vehicle m1 and the vehicle M.

The virtual vehicle-setting part 112 may determine that the lane-change target-position candidate rearward-traveling vehicle m3 during a lane change operation is located at a position between the frontward traveling vehicle m1 and the vehicle M when a rear end part of the lane-change target-position candidate rearward-traveling vehicle m3 is located at a more rearward position than a rear end part of the frontward traveling vehicle m1 and is located at a more frontward position than a rear end part of the vehicle M. The virtual vehicle-setting part 112 may determine that the lane-change target-position candidate rearward-traveling vehicle m3 is located at a more rearward position than the frontward traveling vehicle m1 when a reference point such as the center of gravity of the lane-change target-position candidate rearward-traveling vehicle m3 is located at a more rearward position than a reference point, a front end part, or a rear end part of the frontward traveling vehicle m1. The virtual vehicle-setting part 112 may determine that the lane-change target-position candidate rearward-traveling vehicle m3 is located at a more frontward position than the vehicle M when a reference point such as the center of gravity of the lane-change target-position candidate rearward-traveling vehicle m3 is located at a more frontward position than a reference point, a front end part, or a rear end part of the vehicle M.

In the present embodiment, the virtual vehicle vm1 is set in the vicinity of the frontward outer edge of the detection region DR, and therefore, the lane-change target-position candidate rearward-traveling vehicle m3 that is recognized by the outside recognition unit 104 is located at a more rearward position than the virtual vehicle vm1. Accordingly, when it is determined that the frontward traveling vehicle m1 is not recognized by the outside recognition unit 104 in the process of Step S200 described above (determination result of “No”), it is determined in the determination process of Step S210 that the position of the lane-change target-position candidate rearward-traveling vehicle m3 is located rearward with respect to the position of the virtual vehicle vm1.

When the lane-change target-position candidate rearward-traveling vehicle m3 during a lane change operation is not located at a position between the vehicle M and the frontward traveling vehicle m1 or the virtual vehicle vm1, the virtual vehicle-setting part 112 performs a process of Step S218 described below. On the other hand, when the lane-change target-position candidate rearward-traveling vehicle m3 during a lane change operation is located at a position between the vehicle M and the frontward traveling vehicle m1 or the virtual vehicle vm1, the virtual vehicle-setting part 112 determines whether or not the virtual vehicle vm1 has already been set (Step S212).

When the virtual vehicle vm1 has already been set, the virtual vehicle-setting part 112 erases the set virtual vehicle vm1 (Step S214) and sets a virtual interrupt vehicle vm3# which virtually simulates the lane-change target-position candidate rearward-traveling vehicle m3 during a lane change operation as a movable body in the detection region DR (Step S216).

On the other hand, when the virtual vehicle vm1 has not been set, the virtual vehicle-setting part 112 skips the process of Step S214 and performs the process of Step S216 described above.

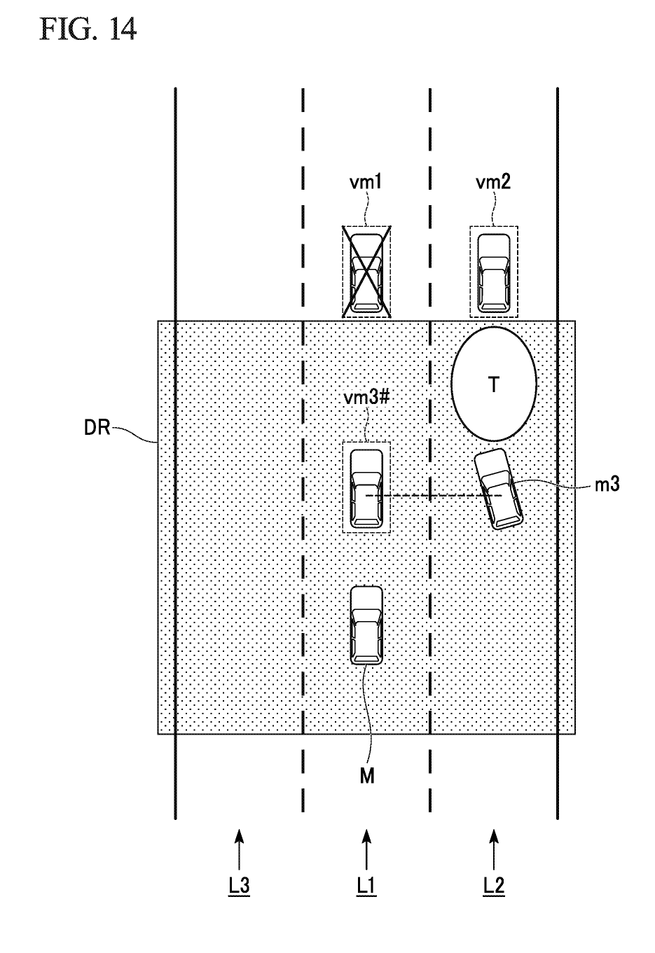

FIG. 14 is a view showing an example of a scene in which a virtual interrupt vehicle vm3# which virtually simulates the lane-change target-position candidate rearward-traveling vehicle m3 is set. The example of FIG. 14 represents a situation in which a frontward traveling vehicle m1 and a lane-change target-position candidate frontward-traveling vehicle m2 are not present in the detection region DR, a lane-change target-position candidate rearward-traveling vehicle m3 is present in the detection region DR, the lane-change target-position candidate rearward-traveling vehicle m3 is located at a frontward position of the vehicle M, and the lane-change target-position candidate rearward-traveling vehicle m3 will perform a lane change from the adjacent lane L2 to the travel lane L1. In such a case, the virtual vehicle-setting part 112 performs the process of Step S216 described above and sets a virtual interrupt vehicle vm3# which virtually simulates the lane-change target-position candidate rearward-traveling vehicle m3 as a movable body in the detection region DR. At this time, the virtual vehicle vm1 shown in FIG. 14 is erased when the virtual interrupt vehicle vm3# is set.

For example, the virtual vehicle-setting part 112 sets a virtual interrupt vehicle vm3#, so as to be located next to the current lane-change target-position candidate rearward-traveling vehicle m3, on the travel lane L1 which is the lane change destination of the lane-change target-position candidate rearward-traveling vehicle m3. More specifically, for example, the virtual vehicle-setting part 112 sets the virtual interrupt vehicle vm3# at a point at which a perpendicular line that is drawn from the reference point such as the center of gravity of the lane-change target-position candidate rearward-traveling vehicle m3 intersects normally with the lane center line on the travel lane L1.

At this time, the virtual vehicle-setting part 112 sets the speed, the acceleration, or the like of the virtual interrupt vehicle vm3# on the basis of the state of the lane-change target-position candidate rearward-traveling vehicle m3. For example, the virtual vehicle-setting part 112 sets a virtual interrupt vehicle vm3# having the same speed as the speed of the lane-change target-position candidate rearward-traveling vehicle m3.

In such a case, the other vehicle position change estimation part 113 estimates a future position change with respect to the virtual vehicle vm2 that is set by the virtual vehicle-setting part 112 in response to the lane-change target-position candidate frontward-traveling vehicle m2 being unrecognized, the virtual interrupt vehicle vm3# that is set by the virtual vehicle-setting part 112 in response to the lane-change target-position candidate rearward-traveling vehicle vm3 performing a lane change operation, and the lane-change target-position candidate rearward-traveling vehicle m3 during a lane change that is recognized by the outside recognition unit 104.

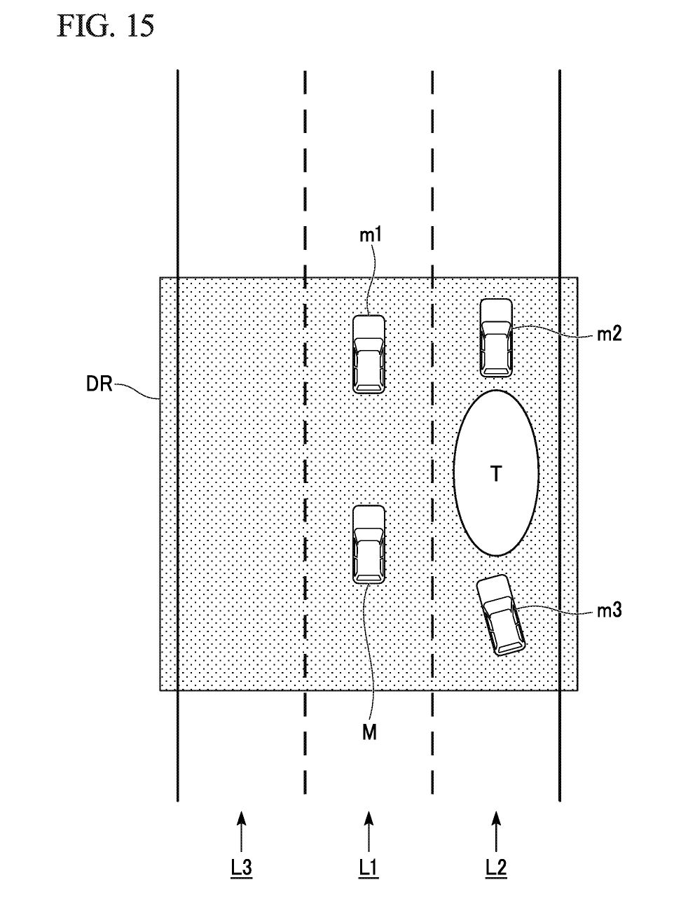

FIG. 15 is a view showing an example of a scene in which the virtual interrupt vehicle vm3# which virtually simulates the lane-change target-position candidate rearward-traveling vehicle m3 is not set. The example of FIG. 15 represents a situation in which a frontward traveling vehicle m1, a lane-change target-position candidate frontward-traveling vehicle m2, and a lane-change target-position candidate rearward-traveling vehicle m3 are present in the detection region DR, and the lane-change target-position candidate rearward-traveling vehicle m3 will perform a lane change from the adjacent lane L2 to the travel lane L1. In such a case, the virtual vehicle-setting part 112 performs the process of Step S210 described above, compares the positions of the frontward traveling vehicle m1, the lane-change target-position candidate rearward-traveling vehicle m3, and the vehicle M, and determines whether or not the lane-change target-position candidate rearward-traveling vehicle m3 is located at a position between the frontward traveling vehicle m1 and the vehicle M. In the example of FIG. 15, the lane-change target-position candidate rearward-traveling vehicle m3 is located at a more rearward position than the vehicle M, and therefore, the virtual vehicle-setting part 112 does not set the virtual interrupt vehicle vm3# which virtually simulates the lane-change target-position candidate rearward-traveling vehicle m3 in the detection region DR.

In such a case, the other vehicle position change estimation part 113 estimates a future position change with respect to the frontward traveling vehicle m1, the lane-change target-position candidate frontward-traveling vehicle m2, and the lane-change target-position candidate rearward-traveling vehicle m3 that are recognized by the outside recognition unit 104.

Next, the virtual vehicle-setting part 112 determines whether or not the lane-change target-position candidate frontward-traveling vehicle m2 is recognized by the outside recognition unit 104 (Step S218). When the lane-change target-position candidate frontward-traveling vehicle m2 is not recognized by the outside recognition unit 104, the virtual vehicle-setting part 112 sets a virtual vehicle vm2 which virtually simulates the lane-change target-position candidate frontward-traveling vehicle m2 as a stationary body in the vicinity of the outer edge of the detection region (Step S220).

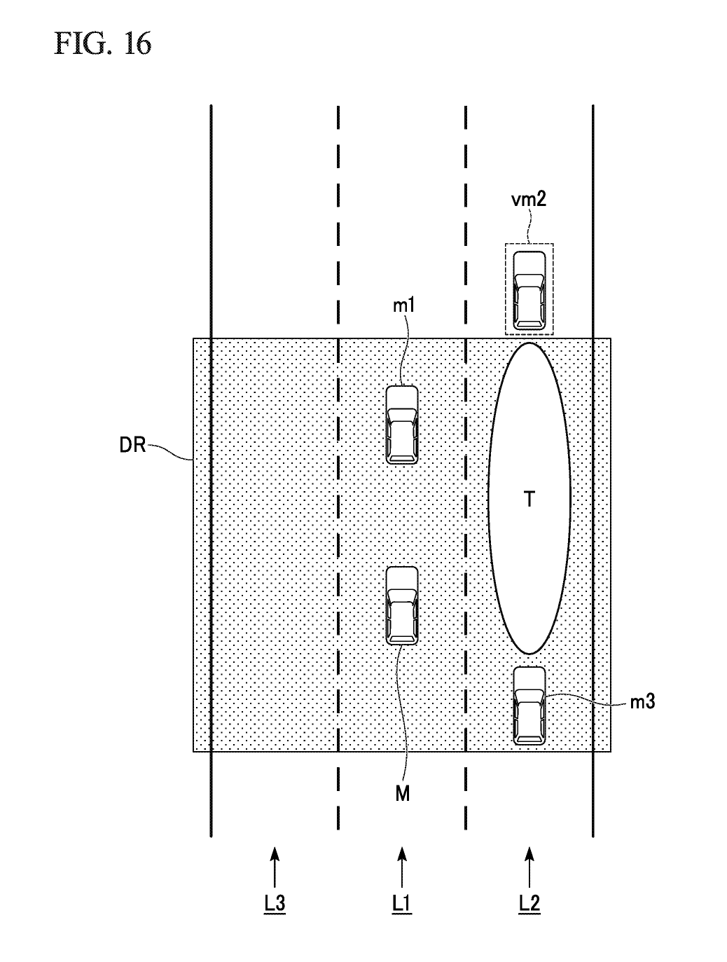

FIG. 16 is a view showing an example of a scene in which the lane-change target-position candidate frontward-traveling vehicle m2 is not recognized in the detection region DR. In the example of FIG. 16, similarly to FIG. 10 and FIG. 13, the travel lane is represented by “L1”, the adjacent lane on the right side of the travel lane L1 is represented by “L2”, the adjacent lane on the left side of the travel lane L1 is represented by “L3”, and the lane change target position candidate is represented by “T”. In the example of FIG. 16, the vehicle m1 is located at a frontward position of the vehicle M in the travel lane L1 and is therefore recognized as the frontward traveling vehicle.

The vehicle m3 is located at a rearward position of the lane change target position candidate T in the adjacent lane L2 and is therefore recognized as the lane-change target-position candidate rearward-traveling vehicle. A vehicle that is located at a frontward position of the lane change target position candidate T in the adjacent lane L2 is not detected, and therefore, the lane-change target-position candidate frontward-traveling vehicle m2 is not recognized. Accordingly, the virtual vehicle-setting part 112 sets a virtual vehicle vm2 of a stationary body in the vicinity of the outer edge of the detection region DR in the frontward direction of the adjacent lane L2.

The arrangement position of the virtual vehicle vm2 is similar to the arrangement position of the virtual vehicle vm1 or the virtual vehicle vm3 described above. For example, the virtual vehicle-setting part 112 may set the virtual vehicle vm2 such that a rear end part of the vehicle body is located on the outside of the detection region DR or may set the virtual vehicle vm2 such that a rear end part of the vehicle body is located on the inside of the detection region DR.

On the other hand, when the lane-change target-position candidate frontward-traveling vehicle m2 is recognized by the outside recognition unit 104, the virtual vehicle-setting part 112 determines whether or not it is estimated that the lane-change target-position candidate frontward-traveling vehicle m2 that is recognized by the outside recognition unit 104 performs a lane change (or will perform a lane change) to the travel lane (Step S222).

When it is not estimated that the lane-change target-position candidate frontward-traveling vehicle m2 that is recognized by the outside recognition unit 104 performs a lane change (or will perform a lane change) to the travel lane, the lane change control unit 110 finishes the process of the present flowchart.

On the other hand, when it is estimated that the lane-change target-position candidate frontward-traveling vehicle m2 that is recognized by the outside recognition unit 104 performs a lane change (or will perform a lane change) to the travel lane, the virtual vehicle-setting part 112 determines whether or not the virtual interrupt vehicle vm3# has already been set (Step S224).

When the virtual interrupt vehicle vm3# has already been set, the lane change control unit 110 finishes the process of the present flowchart. On the other hand, when the virtual interrupt vehicle vm3# has not been set, the virtual vehicle-setting part 112 determines whether or not the lane-change target-position candidate frontward-traveling vehicle m2 during a lane change operation is located at a more rearward position than the frontward traveling vehicle m1 or the virtual vehicle vm1 and at a more frontward position than the vehicle M, that is, whether or not the lane-change target-position candidate frontward-traveling vehicle m2 during a lane change operation is located at a position between the vehicle M and the frontward traveling vehicle m1 or the virtual vehicle vm1 (Step S226). The virtual vehicle-setting part 112 determines the positional relationship of the lane-change target-position candidate frontward-traveling vehicle m2 by comparing the front end part or the rear end part of the vehicle and the reference point such as the center of gravity similarly to a case described above in which the positional relationship of the lane-change target-position candidate rearward-traveling vehicle m3 is determined.

When the lane-change target-position candidate frontward-traveling vehicle m2 during a lane change operation is not located at a position between the vehicle M and the frontward traveling vehicle m1 or the virtual vehicle vm1, the lane change control unit 110 finishes the process of the present flowchart. On the other hand, when the lane-change target-position candidate frontward-traveling vehicle m2 during a lane change operation is located at a position between the vehicle M and the frontward traveling vehicle m1 or the virtual vehicle vm1, the virtual vehicle-setting part 112 determines whether or not the virtual vehicle vm1 has already been set (Step S228).

When the virtual vehicle vm1 has already been set, the virtual vehicle-setting part 112 erases the set virtual vehicle vm1 (Step S230) and sets a virtual interrupt vehicle vm2# which virtually simulates the lane-change target-position candidate frontward-traveling vehicle m2 during a lane change operation as a movable body in the detection region DR (Step S232).

On the other hand, when the virtual vehicle vm1 has not been set, the virtual vehicle-setting part 112 skips the process of Step S230 and performs the process of Step S232 described above.

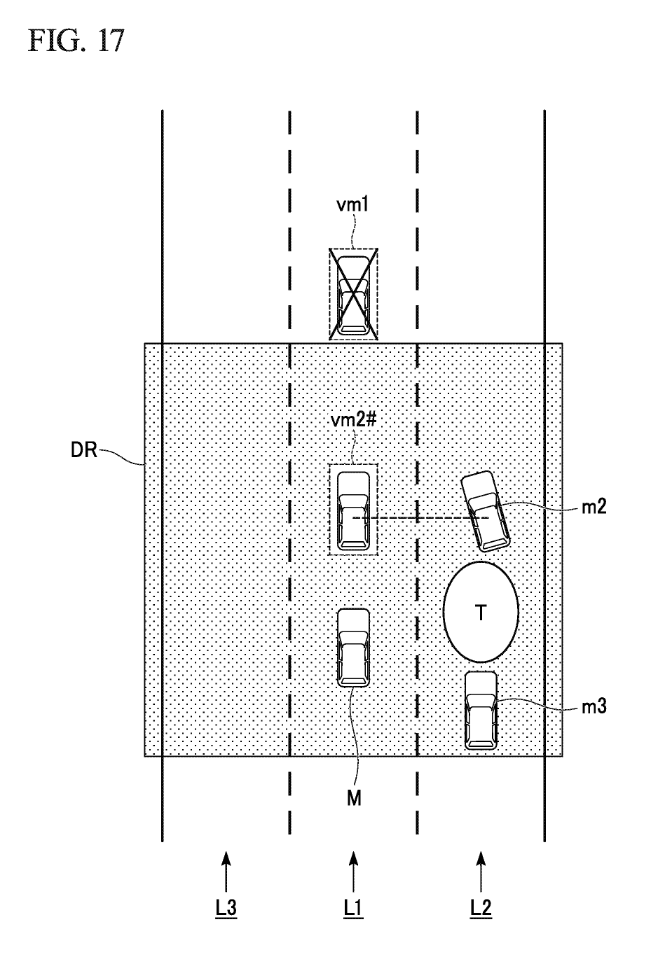

FIG. 17 is a view showing an example of a scene in which the virtual interrupt vehicle vm2# which virtually simulates the lane-change target-position candidate frontward-traveling vehicle m2 is set. The example of FIG. 17 represents a situation in which a frontward traveling vehicle m1 is not present in the detection region DR, a lane-change target-position candidate frontward-traveling vehicle m2 and a lane-change target-position candidate rearward-traveling vehicle m3 are present in the detection region DR, the lane-change target-position candidate frontward-traveling vehicle m2 is located at a frontward position of the vehicle M, and the lane-change target-position candidate frontward-traveling vehicle m2 will perform a lane change from the adjacent lane L2 to the travel lane L1. In such a case, the virtual vehicle-setting part 112 performs the process of Step S232 described above and sets a virtual interrupt vehicle vm2# which virtually simulates the lane-change target-position candidate frontward-traveling vehicle m2 as a movable body in the detection region DR. At this time, the virtual vehicle vm1 shown in FIG. 17 is erased when the virtual interrupt vehicle vm2# is set.

For example, the virtual vehicle-setting part 112 sets the virtual interrupt vehicle vm2#, so as to be located next to the current lane-change target-position candidate frontward-traveling vehicle m2, on the travel lane L1 which is the lane change destination of the lane-change target-position candidate frontward-traveling vehicle m2 similarly to when the virtual interrupt vehicle vm2# is set.

At this time, the virtual vehicle-setting part 112 sets the speed, the acceleration, or the like of the virtual interrupt vehicle vm2# on the basis of the state of the lane-change target-position candidate frontward-traveling vehicle m2. For example, the virtual vehicle-setting part 112 sets a virtual interrupt vehicle vm2# having the same speed as the speed of the lane-change target-position candidate frontward-traveling vehicle m2.

In such a case, the other vehicle position change estimation part 113 estimates a future position change with respect to the virtual interrupt vehicle vm2# that is set by the virtual vehicle-setting part 112 in response to the lane-change target-position candidate frontward-traveling vehicle m2 performing a lane change operation, the lane-change target-position candidate rearward-traveling vehicle m3 that is recognized by the outside recognition unit 104, and the lane-change target-position candidate frontward-traveling vehicle m2 during a lane change that is recognized by the outside recognition unit 104.

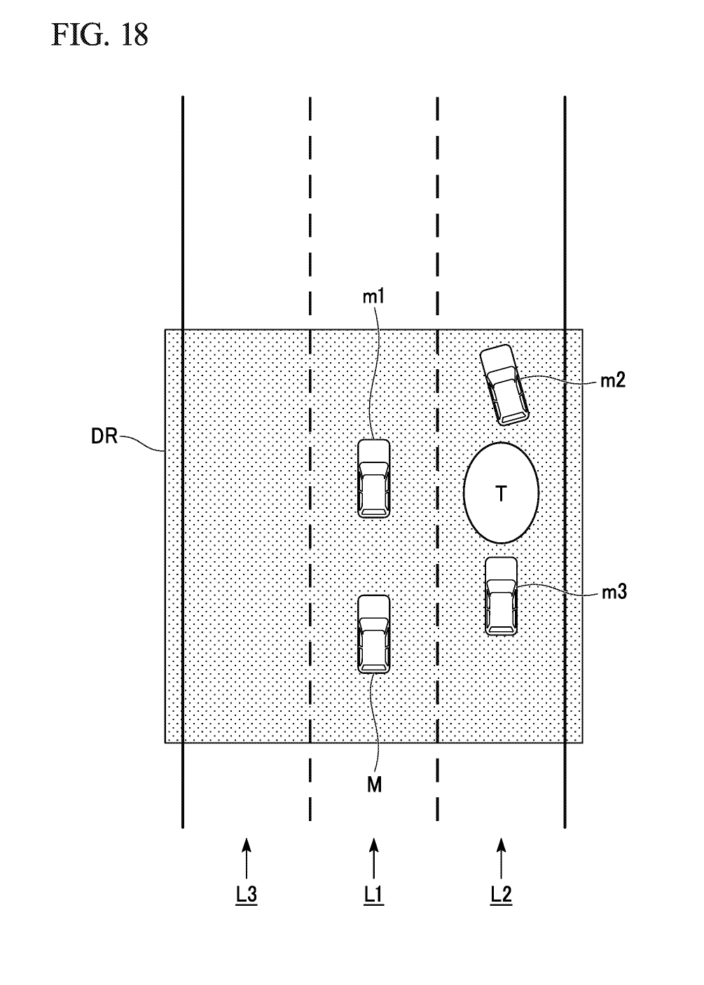

FIG. 18 is a view showing an example of a scene in which the virtual interrupt vehicle vm2# which virtually simulates the lane-change target-position candidate frontward-traveling vehicle m2 is not set. The example of FIG. 18 represents a situation in which a frontward traveling vehicle m1, a lane-change target-position candidate frontward-traveling vehicle m2, and a lane-change target-position candidate rearward-traveling vehicle m3 are present in the detection region DR, and the lane-change target-position candidate frontward-traveling vehicle m2 will perform a lane change from the adjacent lane L2 to the travel lane L1. In such a case, the virtual vehicle-setting part 112 performs the process of Step S226 described above, compares the positions of the frontward traveling vehicle m1, the lane-change target-position candidate frontward-traveling vehicle m2, and the vehicle M, and determines whether or not the lane-change target-position candidate frontward-traveling vehicle m2 is located at a position between the frontward traveling vehicle m1 and the vehicle M. In the example of FIG. 18, the lane-change target-position candidate frontward-traveling vehicle m2 is located at a more frontward position than the frontward traveling vehicle m1, and therefore, the virtual vehicle-setting part 112 does not set the virtual interrupt vehicle vm2# which virtually simulates the lane-change target-position candidate frontward-traveling vehicle m2 in the detection region DR.

In such a case, the other vehicle position change estimation part 113 estimates a future position change with respect to the frontward traveling vehicle m1, the lane-change target-position candidate frontward-traveling vehicle m2, and the lane-change target-position candidate rearward-traveling vehicle m3 that are recognized by the outside recognition unit 104.

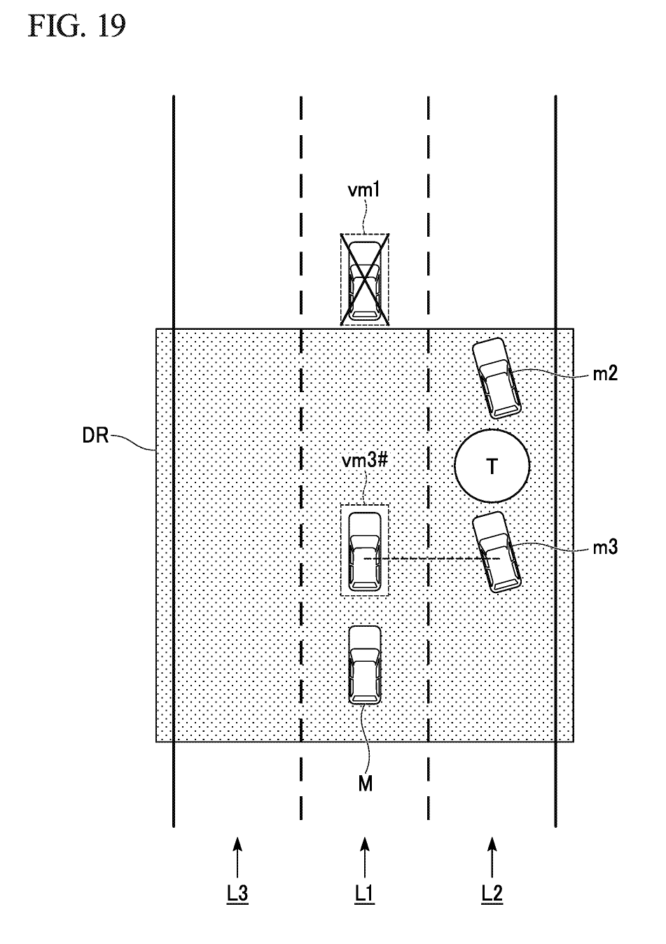

FIG. 19 is a view showing another example of a scene in which the virtual interrupt vehicle vm3# which virtually simulates the lane-change target-position candidate rearward-traveling vehicle m3 is set. The example of FIG. 19 represents a situation in which a frontward traveling vehicle m1 is not present in the detection region DR, a lane-change target-position candidate frontward-traveling vehicle m2 and a lane-change target-position candidate rearward-traveling vehicle m3 are present in the detection region DR, both of the lane-change target-position candidate frontward-traveling vehicle m2 and the lane-change target-position candidate rearward-traveling vehicle m3 are located at a frontward position of the vehicle M, and both of the vehicles will perform a lane change from the adjacent lane L2 to the travel lane L1. In such a case, the virtual vehicle-setting part 112 performs the process of Step S216 described above and first sets a virtual interrupt vehicle vm3# which virtually simulates the lane-change target-position candidate rearward-traveling vehicle m3 as a movable body in the detection region DR. Therefore, the determination result is “YES” in the process of determining whether or not the virtual interrupt vehicle vm3# has already been set by Step S224, and the virtual vehicle-setting part 112 finishes the process of the flowchart without performing a setting process of the virtual interrupt vehicle vm2# which virtually simulates the lane-change target-position candidate frontward-traveling vehicle m2. That is, when both of frontward and rearward vehicles of the lane change target position candidate T will perform a lane change, the virtual vehicle-setting part 112 sets a virtual vehicle which virtually simulates a vehicle (lane-change target-position candidate rearward-traveling vehicle m3) that is traveling at a position closer to the vehicle M preferentially in front of the vehicle M.

The above embodiment is described using an example in which the virtual interrupt vehicle is set when the lane-change target-position candidate frontward-traveling vehicle m2 and the lane-change target-position candidate rearward-traveling vehicle m3 will perform a lane change; however, the embodiment is not limited thereto. For example, when a vehicle that is traveling on an adjacent lane which is different from the adjacent lane on which the lane change target position candidate T is set will perform a lane change onto the travel lane, the virtual vehicle-setting part 112 may set a virtual interrupt vehicle which virtually simulates the vehicle. In the following description, the vehicle that is traveling on an adjacent lane which is different from the adjacent lane on which the lane change target position candidate T is set is referred to as a second adjacent lane-traveling vehicle m4.

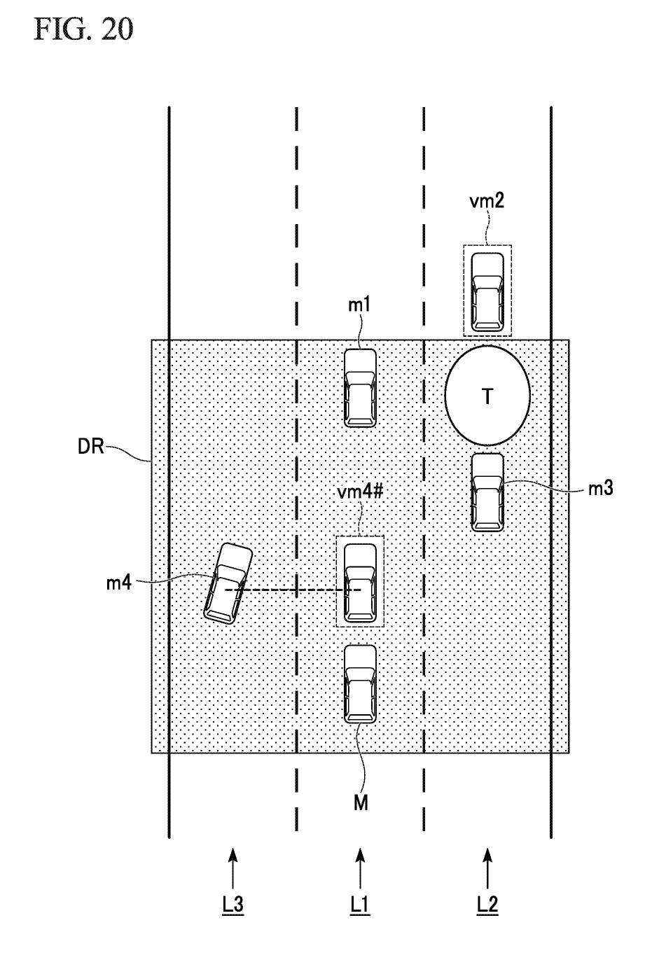

FIG. 20 is a view showing an example of a scene in which a virtual interrupt vehicle vm4# which virtually simulates a second adjacent lane-traveling vehicle m4 is set. The example of FIG. 20 represents a situation in which a lane-change target-position candidate frontward-traveling vehicle m2 is not present in the detection region DR, a frontward traveling vehicle m1, a lane-change target-position candidate rearward-traveling vehicle m3, and a second adjacent lane-traveling vehicle m4 are present in the detection region DR, the second adjacent lane-traveling vehicle m4 is located at a position between the frontward traveling vehicle m1 and the vehicle M, and the second adjacent lane-traveling vehicle m4 will perform a lane change from the adjacent lane L3 to the travel lane L1. In such a case, the virtual vehicle-setting part 112 sets a virtual interrupt vehicle vm4# which virtually simulates the second adjacent lane-traveling vehicle m4 as a movable body in the detection region DR.

At this time, the virtual vehicle-setting part 112 sets the speed, the acceleration, or the like of the virtual interrupt vehicle vm4# on the basis of the state of the second adjacent lane-traveling vehicle m4. For example, the virtual vehicle-setting part 112 sets a virtual interrupt vehicle vm4# having the same speed as the speed of the second adjacent lane-traveling vehicle m4.

In such a case, the other vehicle position change estimation part 113 estimates a future position change with respect to the virtual interrupt vehicle vm4# that is set by the virtual vehicle-setting part 112 in response to the second adjacent lane-traveling vehicle m4 performing a lane change operation, the virtual vehicle vm2 that is set by the virtual vehicle-setting part 112 in response to the lane-change target-position candidate frontward-traveling vehicle m2 being unrecognized, and the lane-change target-position candidate rearward-traveling vehicle m3 that is recognized by the outside recognition unit 104.

In the scene shown in FIG. 20, when the lane-change target-position candidate rearward-traveling vehicle m3 will further perform a lane change from the adjacent lane L2 onto the travel lane L1, the virtual vehicle-setting part 112 compares the positions of the second adjacent lane-traveling vehicle m4 and the lane-change target-position candidate rearward-traveling vehicle m3 and sets a virtual interrupt vehicle which virtually simulates a vehicle which is closer to the vehicle M.

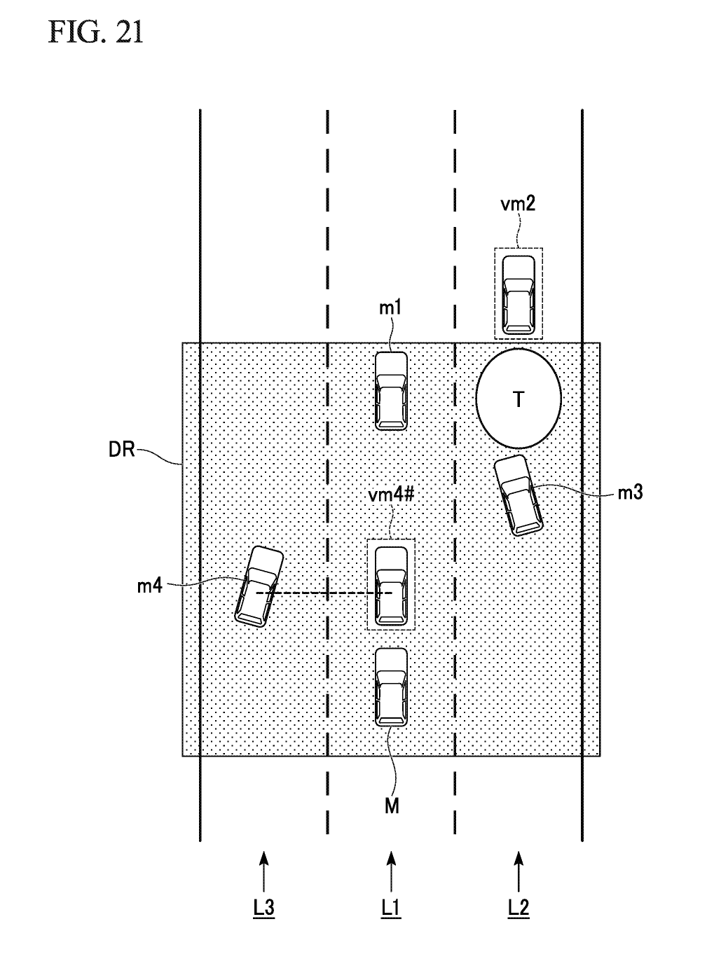

FIG. 21 is a view showing another example of a scene in which a virtual interrupt vehicle vm4# which virtually simulates a second adjacent lane-traveling vehicle m4 is set. Similarly to FIG. 20, the example of FIG. 21 represents a situation in which a lane-change target-position candidate frontward-traveling vehicle m2 is not present in the detection region DR, a frontward traveling vehicle m1, a lane-change target-position candidate rearward-traveling vehicle m3, and a second adjacent lane-traveling vehicle m4 are present in the detection region DR, the second adjacent lane-traveling vehicle m4 and the lane-change target-position candidate rearward-traveling vehicle m3 are located at a position between the frontward traveling vehicle m1 and the vehicle M, and the second adjacent lane-traveling vehicle m4 will perform a lane change from the adjacent lane L3 to the travel lane L1. In addition, the example of FIG. 21 represents a situation in which the lane-change target-position candidate rearward-traveling vehicle m3 will further perform a lane change from the adjacent lane L2 onto the travel lane L1. In such a case, the second adjacent lane-traveling vehicle m4 is present at a position closer to the vehicle M than the lane-change target-position candidate rearward-traveling vehicle m3, and therefore, the virtual vehicle-setting part 112 sets a virtual interrupt vehicle vm4# which virtually simulates the second adjacent lane-traveling vehicle m4 preferentially as a movable body in the detection region DR.

According to the process of the flowchart described above, the lane change control unit 110 can set a variety of virtual vehicles in response to the lane change operation of the peripheral vehicle.

The flowchart of FIG. 7 is described. When the virtual vehicle is not set in the process of Step S102 described above, that is, when the frontward traveling vehicle, the lane-change target-position candidate frontward-traveling vehicle, and the lane-change target-position candidate rearward-traveling vehicle are recognized by the outside recognition unit 104, the other vehicle position change estimation part 113 estimates a future position change with respect to the three monitored vehicles (Step S104).

It is possible to estimate the future position change, for example, on the basis of a constant speed model in which it is assumed that a vehicle travels while keeping the current speed, a constant acceleration model in which it is assumed that a vehicle travels while keeping the current acceleration, or a variety of other models. The other vehicle position change estimation part 113 may consider the steering angle of a monitored vehicle (including a virtual vehicle) with which the vehicle M will interfere with a high chance when changing a lane or may assume that the monitored vehicle travels while keeping the current travel lane to estimate the position change without considering the steering angle. In the following description, it is assumed that the above monitored vehicle travels while keeping the current speed and maintaining the travel lane, and the position change is estimated.

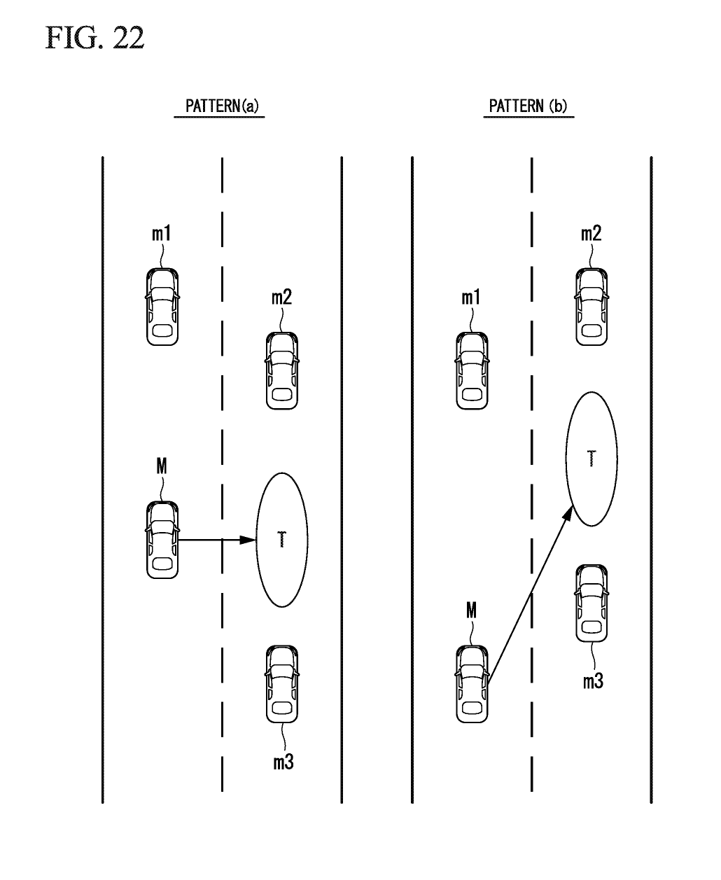

FIG. 22 is a view showing an example of, in a case where a monitored vehicle that becomes a determination target is recognized, a positional relationship between the vehicle M and the peripheral vehicle. In the drawing, “M” represents a vehicle, “m1” represents a frontward traveling vehicle, “m2” represents a lane-change target-position candidate frontward-traveling vehicle, “m3” represents a lane-change target-position candidate rearward-traveling vehicle, and “T” represents a lane change target position candidate For example, Pattern (a) represents a positional relationship of m1-m2-M-m3 in the order from the vehicle proceeding direction and shows an example in which the vehicle M performs a lane change without changing the relative position with the monitored vehicle. Pattern (b) represents a positional relationship of m2-m1-m3-M in the order from the vehicle proceeding direction and shows an example in which the vehicle M performs a lane change while advancing (relatively accelerating) the relative position with the monitored vehicle.

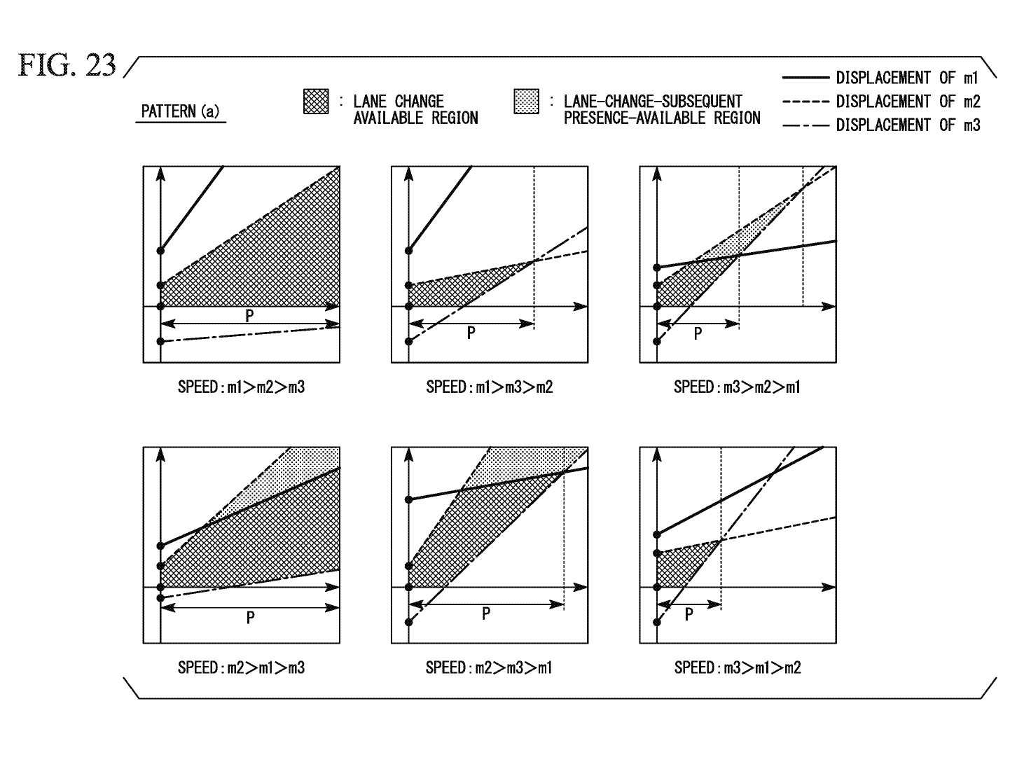

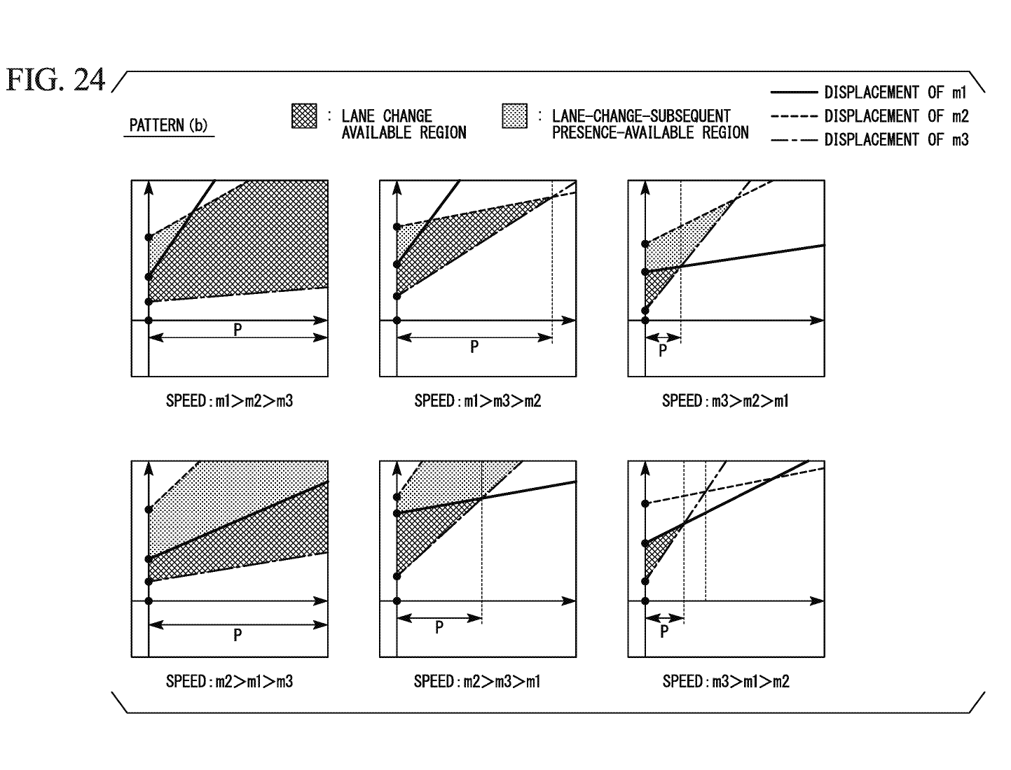

For example, the other vehicle position change estimation part 113 categorizes the future position change on the basis of speed models of the monitored vehicles m1, m2, and m3 for each pattern in which the vehicle positional relationship is categorized. FIG. 23 is a view showing patterns into which the position change of the peripheral vehicle is categorized with respect to Pattern (a) of the vehicle positional relationship. FIG. 24 is a view showing patterns into which the position change of the peripheral vehicle is categorized with respect to Pattern (b) of the vehicle positional relationship. The vertical axis in FIG. 23 and FIG. 24 represents a displacement with respect to the proceeding direction with reference to the vehicle M, and the horizontal axis represents an elapsed time.

A lane-change-subsequent presence-available region in FIG. 23 and FIG. 24 shows a displacement region in which the vehicle M is capable of being present after performing a lane change when the monitored vehicle (m1, m2, m3) continues traveling in the same trend. For example, a drawing of “speed: m2>m1>m3” in FIG. 23 shows that the lane change available region is on a more lower side than the displacement of the frontward traveling vehicle m1, that is, although the vehicle M is restricted so as not to be a more frontward position than the frontward traveling vehicle m1 before performing a lane change, it is no problem for the vehicle M to be a more frontward position than the frontward traveling vehicle m1 after performing a lane change. The lane-change-subsequent presence-available region is used for the process of the travel plan generation part 114. The pattern into which the vehicle positional relationship is categorized may be, for example, a pattern that represents a positional relationship such as an order of m2-m1-M-m3 and an order of m1-M-m2-m3 in addition to Patterns (a), (b) described above. The patterns may be categorized depending on the number of vehicles. In the example described above, the pattern that represents the vehicle positional relationship is categorized into six patterns.

When a virtual vehicle is set in the process of Step S102 described above, the other vehicle position change estimation part 113 estimates a future position change with respect to the monitored vehicle that is recognized by the outside recognition unit 104 and the virtual vehicle that is set by the virtual vehicle-setting part 112 in response to a monitored vehicle being not recognized (Step S104).

For example, when the lane-change target-position candidate frontward-traveling vehicle and the lane-change target-position candidate rearward-traveling vehicle are recognized, and the frontward traveling vehicle is not recognized, the other vehicle position change estimation part 113 estimates a future position change with respect to the lane-change target-position candidate frontward-traveling vehicle and the lane-change target-position candidate rearward-traveling vehicle that are recognized and a virtual vehicle that virtually simulates the unrecognized frontward traveling vehicle.

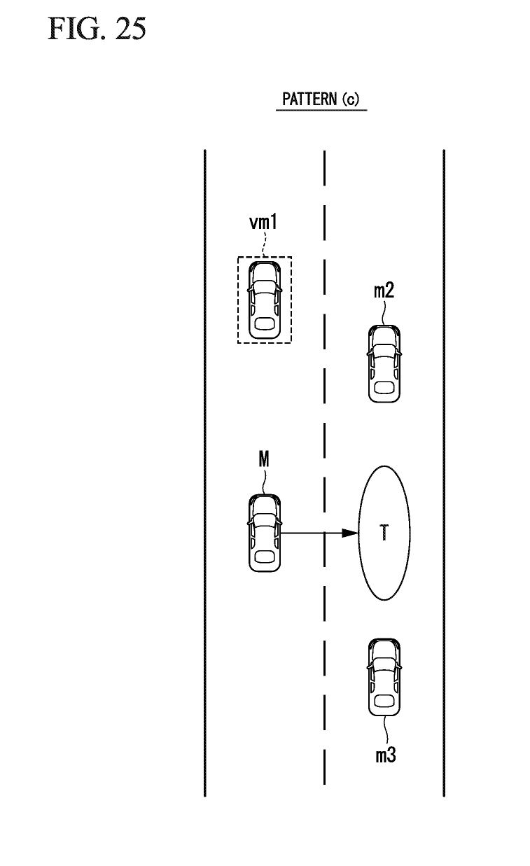

FIG. 25 is a view showing an example of, in a case where part of a monitored vehicle is not recognized, a positional relationship between the vehicle M and the monitored vehicle. In the example of FIG. 25, a frontward traveling vehicle m1 is not recognized, and a virtual vehicle vm1 that virtually simulates the frontward traveling vehicle m1 is set. Hereinafter, a vehicle positional relationship when the virtual vehicle vm1 is set is described as Pattern (c). For example, Pattern (c) represents a positional relationship of vm1-m2-M-m3 in the order from the vehicle proceeding direction and shows an example in which the vehicle M performs a lane change without changing the relative position with the peripheral vehicle (monitored vehicle).

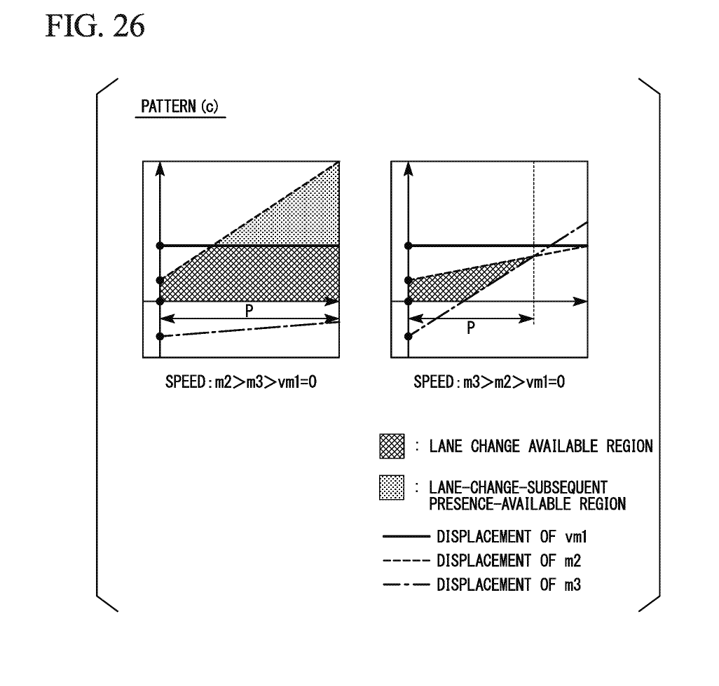

In the case of the positional relationship of Pattern (c), the other vehicle position change estimation part 113 categorizes the future position change on the basis of speed models of the virtual vehicle vm1, the lane-change target-position candidate frontward-traveling vehicle m2, and the lane-change target-position candidate rearward-traveling vehicle m3. FIG. 26 is a view showing patterns into which the position change of the peripheral vehicle is categorized with respect to Pattern (c) of the vehicle positional relationship. The vertical axis in FIG. 24 represents a displacement with respect to the proceeding direction with reference to the vehicle M, and the horizontal axis represents an elapsed time, similarly to FIG. 23 and FIG. 24. In the example of FIG. 26, the future position change is estimated using a model in which the virtual vehicle vm1 is assumed to be a stationary body having a speed of zero.

When all of the frontward traveling vehicle, the lane-change target-position candidate frontward-traveling vehicle, and the lane-change target-position candidate rearward-traveling vehicle are not recognized by the outside recognition unit 104, the other vehicle position change estimation part 113 estimates a future position change with respect to virtual vehicles that correspond to all of the peripheral vehicles. In such a case, the other vehicle position change estimation part 113 estimates a future position change on the basis of a speed model in accordance with the speed of each virtual vehicle that is set by the virtual vehicle-setting part 112.

The vehicle that is taken into consideration is not limited to the frontward traveling vehicle, the lane-change target-position candidate frontward-traveling vehicle, and the lane-change target-position candidate rearward-traveling vehicle described above; and, for example, the other vehicle position change estimation part 113 may take a vehicle that is traveling on the travel lane and that is different from the above-described frontward traveling vehicle or a vehicle that is traveling on the adjacent lane and that is different from the above-described lane-change target-position candidate frontward-traveling vehicle and the above-described lane-change target-position candidate rearward-traveling vehicle into consideration and estimate a future position change. The other vehicle position change estimation part 113 may take a vehicle (for example, the second adjacent lane vehicle m4 and the like) that is traveling on a further adjacent lane of the adjacent lane and estimate a future position change.

Next, the control plan generation part 114 generates a control plan for a lane change on the basis of the position change of the peripheral vehicle that is estimated by the other vehicle position change estimation part 113 for each lane change target position candidate T that is set by the target position candidate-setting part 111 (Step S106).

The process of Step S106 is described. In the following description, an example of a speed relationship of m1>m3>m2 in Pattern (b) of the above-described vehicle positional relationship is described. For example, the control plan generation part 114 determines a start time point and an end time point of a lane change on the basis of the position change of the peripheral vehicle (monitored vehicle) that is estimated by the other vehicle position change estimation part 113 and determines the speed of the vehicle M such that a lane change is performed in a period (lane change available period P) from the start time point to the end time point. In order to determine the start time point of the lane change, a parameter such as “a time point when the vehicle M overtakes the lane-change target-position candidate rearward-traveling vehicle m3” is present, and in order to solve this, an assumption regarding the acceleration or deceleration of the vehicle M is required. With respect to this point, for example, if accelerating, the control plan generation part 114 derives a speed change curve using the legal speed as the upper limit in a range where the acceleration from the current speed of the vehicle M does not become abrupt acceleration and determines “the time point when the vehicle M overtakes the lane-change target-position candidate rearward-traveling vehicle m3” by using the derived speed change curve together with the position change of the lane-change target-position candidate rearward-traveling vehicle m3. Thereby, the control plan generation part 114 determines the start time point of the lane change.

In order to determine the end time point of the lane change, a parameter such as “a time point when the lane-change target-position candidate rearward-traveling vehicle m3 catches up with the frontward traveling vehicle m1” and “a time point when the lane-change target-position candidate rearward-traveling vehicle m3 catches up with the lane-change target-position candidate frontward-traveling vehicle m2” is taken into consideration, and an assumption regarding the acceleration or deceleration of the vehicle M is made to solve the problem. The control plan generation part 114 determines as the end time point, for example, when the lane-change target-position candidate rearward-traveling vehicle m3 catches up with the lane-change target-position candidate frontward-traveling vehicle m2, and the distance between the lane-change target-position candidate rearward-traveling vehicle m3 and the lane-change target-position candidate frontward-traveling vehicle m2 becomes a predetermined distance. In this way, the control plan generation part 114 determines the start time point and the end time point of the lane change and thereby derives the lane change available period P.

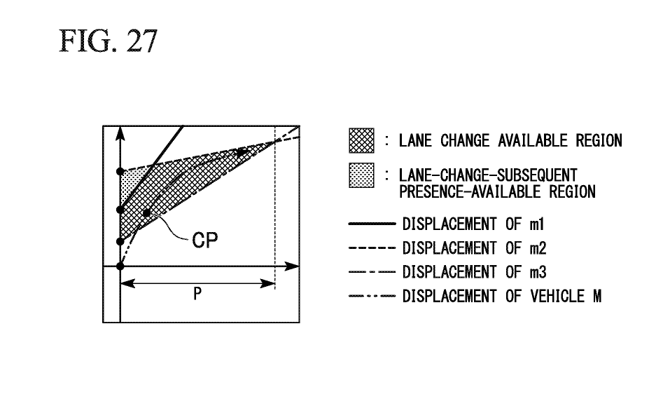

The control plan generation part 114 obtains a limitation of the speed of the vehicle M at which the vehicle M is capable of entering the lane change available region in the derived lane change available period P and generates a control plan used for the lane change in accordance with the limitation of the speed. FIG. 27 is a view showing an example of the control plan used for the lane change that is generated by the control plan generation part 114. The vertical axis in FIG. 27 represents a displacement with respect to the proceeding direction with reference to the vehicle M, and the horizontal axis represents an elapsed time. The frontward traveling vehicle is represented by “m1”, the lane-change target-position candidate frontward-traveling vehicle is represented by “m2”, and the lane-change target-position candidate rearward-traveling vehicle is represented by “m3”. In the example of FIG. 27, the lane change available region is a region that is smaller than the displacement of the frontward traveling vehicle m1, that is smaller than the displacement of the lane-change target-position candidate frontward-traveling vehicle m2, and that is larger than the displacement of the lane-change target-position candidate rearward-traveling vehicle m3. That is, the limitation of the speed of the vehicle M is set in a speed range in which the vehicle M does not catch up with the frontward traveling vehicle m1 and the vehicle M overtakes the lane-change target-position candidate rearward-traveling vehicle m3 in the period (lane change available period P) until the lane-change target-position candidate rearward-traveling vehicle m3 catches up with the lane-change target-position candidate frontward-traveling vehicle m2.

The limitation of the speed of the vehicle M may include traveling so as to follow up the lane-change target-position candidate frontward-traveling vehicle m2 which becomes a frontward traveling vehicle after the lane change (in a state of being located at a position between the lane-change target-position candidate frontward-traveling vehicle m2 and the lane-change target-position candidate rearward-traveling vehicle m3).

In this case, at a time point when the follow-up travel is started, the vehicle M may be deviated from the lane change available region and enter a lane-change-subsequent presence-available region. As shown in FIG. 27, the lane-change-subsequent presence-available region is a region in which the displacement of the frontward traveling vehicle m1 is smaller than the displacement of the lane-change target-position candidate frontward-traveling vehicle m2. That is, entering the lane-change-subsequent presence-available region from the lane change available region represents a transition from when maintaining a state in which the vehicle M does not come to a more frontward position than the frontward traveling vehicle m1 according to the limitation of the speed described above before performing the lane change to a state the vehicle M comes to a more frontward position than the frontward traveling vehicle m1 after performing the lane change.

Further, when it is necessary to perform a lane change after the vehicle M overtakes the lane-change target-position candidate rearward-traveling vehicle m3, the control plan generation part 114 sets the limitation of the speed of the vehicle M such that the lane change is started at a point (for example, CP in FIG. 27) where the displacement of the vehicle M is sufficiently larger than the displacement of the lane-change target-position candidate rearward-traveling vehicle m3. The control plan generation part 114 draws a trajectory (track) that represents the change of the displacement of the vehicle M indicated in FIG. 27 such that the limitation of the speed that is set in this way is satisfied and derives the trajectory (track) as a control plan. The control plan generation part 114 may generate, for example, a control plan such that at a speed at which the relative position between the vehicle M and a frontward traveling vehicle is constant, the vehicle M follows up the frontward traveling vehicle.

The lane change control unit 110 determines whether or not the process of Step S100 to S106 is performed with respect to all of the lane change target position candidates T (Step S108). When the process of Steps S100 to S106 is not performed with respect to all of the lane change target position candidates T, the routine returns to Step S100, and the next lane change target position candidate T is selected to perform the subsequent process.

When the process of Steps S100 to S106 is performed with respect to all of the lane change target position candidates T, the target position determination part 116 evaluates corresponding control plans and thereby determines the lane change target position T# (Step S110).

The target position determination part 116 determines the lane change target position T#, for example, from the viewpoint of safety or efficiency. The target position determination part 116 refers to the control plan that corresponds to each of the lane change target position candidates T and preferentially selects one in which the spacing with the frontward and rearward vehicles at the time of the lane change is large, one in which the speed is close to the legal speed, one in which acceleration or deceleration that is required at the time of the lane change is small, or the like as the lane change target position T#. In this way, one lane change target position T# and one control plan are determined.

According to the process sequence described above, the process of the present flowchart is finished.

[Travel Control]

The travel control part 120 sets a control mode to an automated driving mode or a manual driving mode according to a control by the control switch unit 122 and controls a control target that includes part of or all of the travel drive force output device 72, the steering device 74, and the brake device 76 in accordance with the set control mode. The travel control part 120 reads the action plan information 136 that is generated by the action plan generation unit 106 at the automated driving mode and controls the control target on the basis of the event that is included in the read action plan information 136. When the event is a lane change event, the travel control part 120 determines the control amount (for example, a rotation number) of the electric motor in a steering device 92 and the control amount (for example, a throttle opening degree of an engine, a shift step, and the like) of the ECU in a travel drive force output device 90 in accordance with the control plan that is generated by the control plan generation part 114. The travel control part 120 outputs information indicating the control amount that is determined for each event to the corresponding control target. Thereby, each device (72, 74, 76) as a control target can control the device as the control target in accordance with the information indicating the control amount that is input from the travel control part 120.

Further, the travel control part 120 appropriately adjusts the determined control amount on the basis of a detection result of the vehicle sensor 60.

The travel control part 120 controls the control target on the basis of an operation detection signal that is output by the operation detection sensor 80 at the manual driving mode. For example, the travel control part 120 outputs the operation detection signal that is output by the operation detection sensor 80 as is to each device as the control target.

The control switch unit 122 switches the control mode of the vehicle M by the travel control part 120 from the automated driving mode to the manual driving mode or from the manual driving mode to the automated driving mode on the basis of the action plan information 136 that is generated by the action plan generation unit 106 and that is stored in the storage part 130. The control switch unit 122 switches the control mode of the vehicle M by the travel control part 120 from the automated driving mode to the manual driving mode or from the manual driving mode to the automated driving mode on the basis of the control mode designation signal that is input from the switch 82. That is, the control mode of the travel control part 120 can be arbitrarily changed while traveling or while stopping by the operation of the driver or the like.

The control switch unit 122 switches the control mode of the vehicle M by the travel control part 120 from the automated driving mode to the manual driving mode on the basis of the operation detection signal that is input from the operation detection sensor 80. For example, the control switch unit 122 switches the control mode of the travel control part 120 from the automated driving mode to the manual driving mode when the operation amount that is included in the operation detection signal exceeds a threshold value, that is, when an operation device 70 accepts an operation at the operation amount that exceeds the threshold value. For example, the control switch unit 122 switches the control mode of the travel control part 120 from the automated driving mode to the manual driving mode when the steering wheel, the accelerator pedal, or the brake pedal is operated at the operation amount that exceeds the threshold value by the driver in a case where the vehicle M is automatically traveling by the travel control part 120 that is set in the automated driving mode. Thereby, the vehicle control apparatus 100 can switch the driving mode to the manual driving mode immediately, without an operation of the switch 82, by an operation that is abruptly performed by the driver when an object such as a person dashes into the road or when a frontward traveling vehicle suddenly stops. As a result, the vehicle control apparatus 100 can respond to an operation in an emergency by the driver, and it is possible to enhance safety when traveling.

According to the vehicle control apparatus 100, the vehicle control method, and the vehicle control program in the first embodiment described above, the outside recognition unit 104 that estimates a lane change by a peripheral vehicle which is traveling around the vehicle M; the virtual vehicle-setting part 112 that sets a virtual vehicle, which virtually simulates the peripheral vehicle as a recognition target, on a lane of the lane change destination of the peripheral vehicle when the lane change by the peripheral vehicle is estimated by the outside recognition unit; the control plan generation part 114 that generates a control plan of the vehicle M on the basis of the virtual vehicle which is set by the virtual vehicle-setting part 112; and the travel control part 120 that controls acceleration, deceleration, or steering of the vehicle M on the basis of the control plan which is generated by the control plan generation part 114 are included. Thereby, it is possible to perform flexible automated driving in response to the movement of the peripheral vehicle.

According to the vehicle control apparatus 100, the vehicle control method, and the vehicle control program in the first embodiment, when a peripheral vehicle during a lane change is closer to the vehicle M than a frontward traveling vehicle, a virtual interrupt vehicle is set at a frontward position of the vehicle M, the virtual interrupt vehicle that is set in place of the frontward traveling vehicle is referred to, and a control plan of the vehicle M is generated. Therefore, it is possible to perform further flexible automated driving in response to the movement of the peripheral vehicle.

### Second Embodiment

Hereinafter, a second embodiment is described. A vehicle control apparatus 100 in the second embodiment is different from the first and second embodiments in that a virtual vehicle is set on the basis of a relative speed Vr between the speed of a monitored vehicle and the speed of the vehicle M. Hereinafter, such a difference is mainly described.

The virtual vehicle-setting part 112 in the second embodiment determines whether or not the lane change destination of the monitored vehicle is the travel lane and sets a region (hereinafter, referred to as a “non-setting region NSR”), in which the virtual vehicle is not set, at a frontward position of the vehicle M on the basis of the relative speed Vr between the speed of the monitored vehicle and the speed of the vehicle M when the lane change destination of the monitored vehicle is the travel lane.

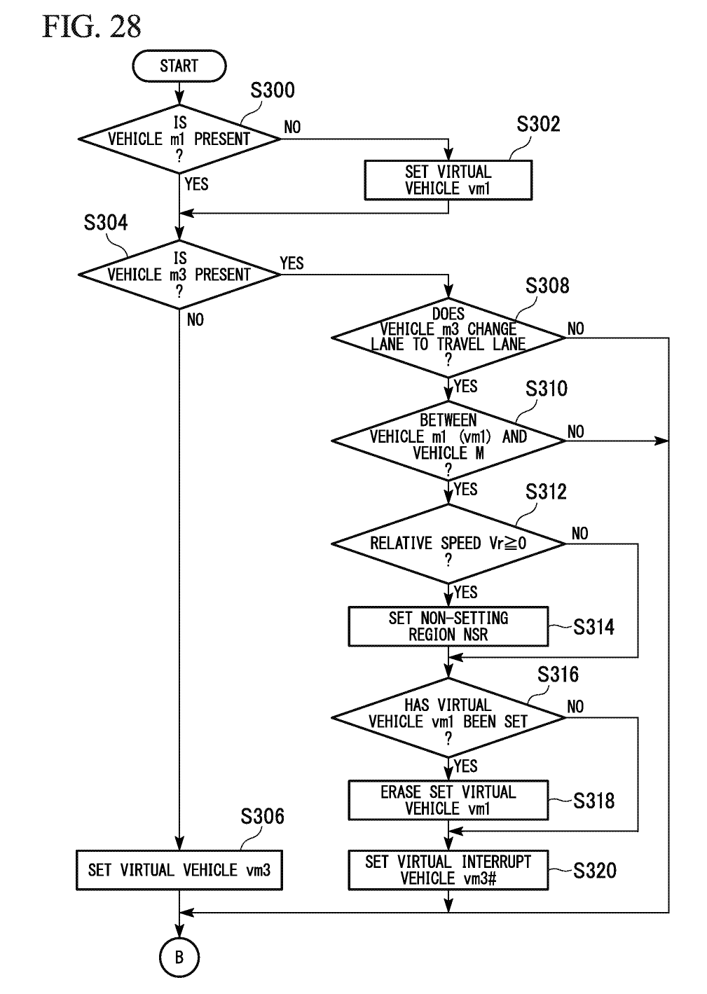

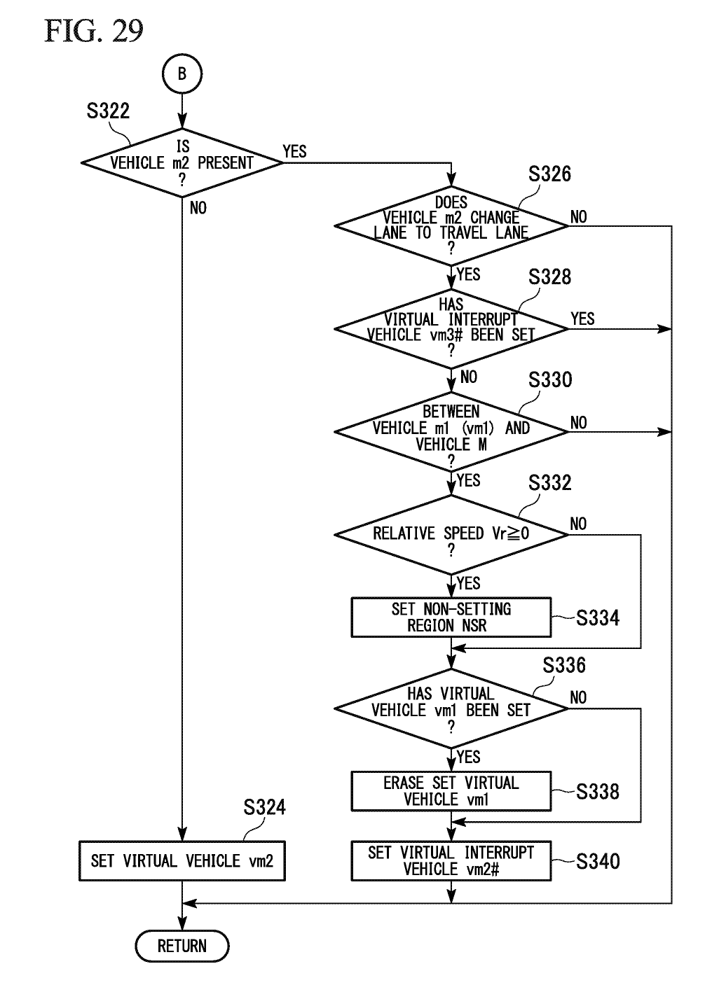

Hereinafter, a specific process of the lane change control unit 110 in the second embodiment is described with reference to a flowchart. FIG. 28 and FIG. 29 are flowcharts showing an example of a process flow of the lane change control part 110 in the second embodiment. The process of the present flowchart corresponds to the process of Step S102 of the flowchart of FIG. 7 described in the above first embodiment.

First, the virtual vehicle-setting part 112 determines whether or not a frontward traveling vehicle m1 is recognized by the outside recognition unit 104 (Step S300). When a frontward traveling vehicle m1 is not recognized by the outside recognition unit 104, the virtual vehicle-setting part 112 sets a virtual vehicle vm1 which virtually simulates a frontward traveling vehicle m1 as a stationary body in the vicinity of the outer edge of the detection region (Step S302).

On the other hand, when the frontward traveling vehicle m1 is recognized by the outside recognition unit 104, or when the virtual vehicle vm1 is set, the virtual vehicle-setting part 112 determines whether or not the lane-change target-position candidate rearward-traveling vehicle m3 is recognized by the outside recognition unit 104 (Step S304). When the lane-change target-position candidate rearward-traveling vehicle m3 is not recognized by the outside recognition unit 104, the virtual vehicle-setting part 112 sets a virtual vehicle vm3 which virtually simulates the lane-change target-position candidate rearward-traveling vehicle m3 as a movable body in the vicinity of the outer edge of the detection region (Step S306).

On the other hand, when the lane-change target-position candidate rearward-traveling vehicle m3 is recognized by the outside recognition unit 104, the virtual vehicle-setting part 112 determines whether or not it is estimated that the lane-change target-position candidate rearward-traveling vehicle m3 that is recognized by the outside recognition unit 104 performs a lane change (or will perform a lane change) to the travel lane (Step S308).

When it is not estimated that the lane-change target-position candidate rearward-traveling vehicle m3 that is recognized by the outside recognition unit 104 performs a lane change (or will perform a lane change) to the travel lane, the virtual vehicle-setting part 112 performs a process of Step S322 described below.

On the other hand, when it is estimated that the lane-change target-position candidate rearward-traveling vehicle m3 that is recognized by the outside recognition unit 104 performs a lane change (or will perform a lane change) to the travel lane, the virtual vehicle-setting part 112 determines whether or not the lane-change target-position candidate rearward-traveling vehicle m3 during a lane change operation is located at a more rearward position than the frontward traveling vehicle m1 or the virtual vehicle vm1 and at a more frontward position than the vehicle M, that is, whether or not the lane-change target-position candidate rearward-traveling vehicle m3 during a lane change operation is located at a position between the vehicle M and the frontward traveling vehicle m1 or the virtual vehicle vm1 (Step S310).

When the lane-change target-position candidate rearward-traveling vehicle m3 during a lane change operation is not located at a position between the vehicle M and the frontward traveling vehicle m1 or the virtual vehicle vm1, the virtual vehicle-setting part 112 performs a process of Step S322 described below.

On the other hand, when the lane-change target-position candidate rearward-traveling vehicle m3 during a lane change operation is located at a position between the vehicle M and the frontward traveling vehicle m1 or the virtual vehicle vm1, it is determined whether or not the relative speed Vr between the speed of the lane-change target-position candidate rearward-traveling vehicle m3 and the speed of the vehicle M is equal to or more than zero (Step S312). The relative speed Vr is a value obtained by subtracting the speed value of the vehicle M from the speed value of the lane-change target-position candidate rearward-traveling vehicle m3.

When the relative speed Vr is equal to or more than zero, the virtual vehicle-setting part 112 sets a non-setting region NSR at a frontward position of the vehicle M (Step S314).

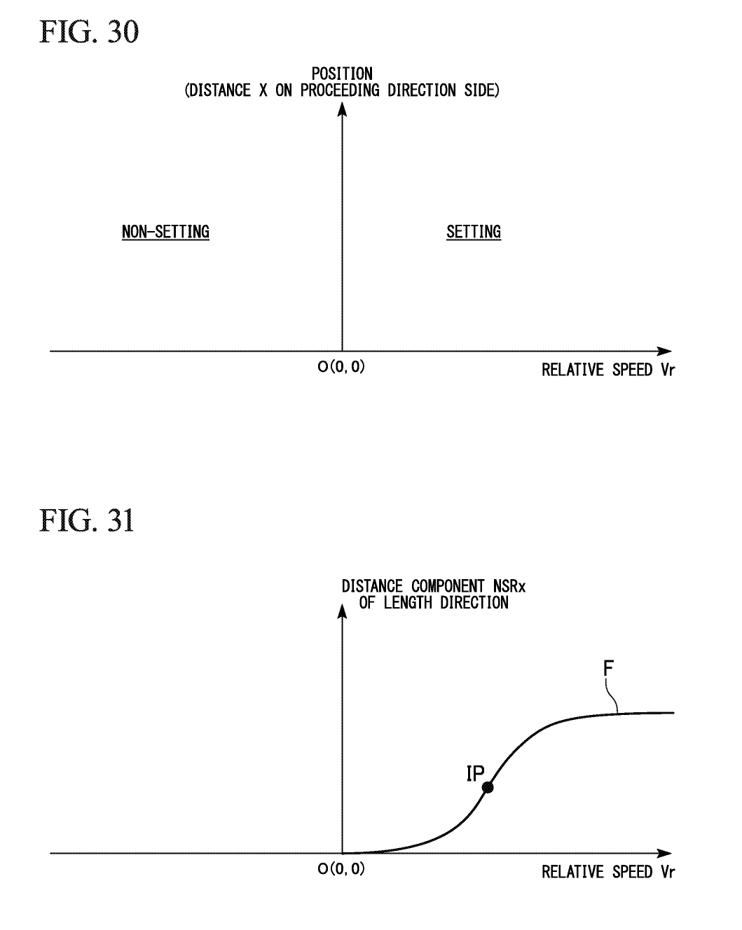

FIG. 30 is a view schematically representing whether or not a non-setting region NSR is set. In FIG. 30, the vertical axis represents a distance (position) on a proceeding direction side, and the horizontal axis represents a relative speed Yr.

A point O shown in FIG. 30 is an origin coordinate, and the relative speed Vr of zero and the position of the vehicle M are reference coordinates. Accordingly, when a monitored vehicle is located at a more frontward position than the vehicle M, the value in the vertical axis is a positive value. When the speed of a monitored vehicle is larger than the speed of the vehicle M, the relative speed Vr is equal to or more than zero, and the value in the horizontal axis is a positive value.

As shown in FIG. 30, the virtual vehicle-setting part 112 sets a non-setting region NSR when both of the value in the vertical axis and the value in the horizontal axis are positive values. That is, the virtual vehicle-setting part 112 sets a non-setting region NSR when the monitored vehicle is located at a more frontward position than the vehicle M and the speed of the monitored vehicle is larger than the speed of the vehicle M.

The virtual vehicle-setting part 112 determines the region area of the non-setting region NSR on the basis of the relative speed Yr. For example, a distance component NSRy of a lane width direction of the non-setting region NSR and a distance component NSRx of a lane length direction are determined, and the region area of the non-setting region NSR is determined.

FIG. 31 is a view showing an example of a relationship between a distance component NSRx of a lane length direction in the non-setting region NSR and a relative speed Yr. A point O in the drawing is an origin coordinate, and the relative speed Vr of zero and the distance component NSRx of zero are reference coordinates. In the example of FIG. 31, the distance component NSRx is represented by a function F that exponentially increases in accordance with the increase of the relative speed Vr in a range from the original point O to an inflection point IP and that logarithmically (or in a positive square root function characteristic) increases in accordance with the increase of the relative speed Vr in a range from the inflection point IP and saturates along an asymptotic line. For example, such a function F may be represented by a graphic map as shown in FIG. 31 or may be represented as table data in which a distance component NSRx is associated with a relative speed Vr for some sample points. Such a function F (or a map or table data) is stored in advance in the storage part 130 as non-setting region deriving information 138. Accordingly, the virtual vehicle-setting part 112 refers to the non-setting region deriving information 138, for example, the relative speed Vr is substituted for the function F described above, and the distance component NSRx of the lane length direction in the non-setting region NSR is determined. The function described above is an example and may be represented by another function.

The virtual vehicle-setting part 112 determines that the distance component NSRy of the lane width direction in the non-setting region NSR is, for example, the same value as the width of the travel lane L1.

On the other hand, when the relative speed Vr is neither equal to nor more than zero, or when the non-setting region NSR is set, the virtual vehicle-setting part 112 determines whether or not a virtual vehicle vm1 has already been set (Step S316). When the virtual vehicle vm1 has already been set, the virtual vehicle-setting part 112 erases the set virtual vehicle vm1 (Step S318) and sets a virtual interrupt vehicle vm3# which virtually simulates the lane-change target-position candidate rearward-traveling vehicle m3 during a lane change operation as a movable body in the detection region DR that excludes the non-setting region NSR (Step S320).

On the other hand, when the virtual vehicle vm1 is not set, the virtual vehicle-setting part 112 skips the process of Step S318 and performs the process of Step S320 described above.

Next, the virtual vehicle-setting part 112 determines whether or not the lane-change target-position candidate frontward-traveling vehicle m2 is recognized by the outside recognition unit 104 (Step S322). When the lane-change target-position candidate frontward-traveling vehicle m2 is not recognized by the outside recognition unit 104, the virtual vehicle-setting part 112 sets a virtual vehicle vm2 which virtually simulates the lane-change target-position candidate frontward-traveling vehicle m2 as a stationary body in the vicinity of the outer edge of the detection region (Step S324).

On the other hand, when the lane-change target-position candidate frontward-traveling vehicle m2 is recognized by the outside recognition unit 104, the virtual vehicle-setting part 112 determines whether or not the lane-change target-position candidate frontward-traveling vehicle m2 that is recognized by the outside recognition unit 104 is performing an operation which performs a lane change (or which will perform a lane change) to the travel lane (Step S326).

When the lane-change target-position candidate frontward-traveling vehicle m2 that is recognized by the outside recognition unit 104 is not performing an operation which performs a lane change (or which will perform a lane change) to the travel lane, the lane change control unit 110 finishes the process of the present flowchart.

On the other hand, when the lane-change target-position candidate frontward-traveling vehicle m2 that is recognized by the outside recognition unit 104 is performing an operation which performs a lane change (or which will perform a lane change) to the travel lane, the virtual vehicle-setting part 112 determines whether or not a virtual interrupt vehicle vm3# has already been set (Step S328).

When the virtual interrupt vehicle vm3# has already been set, the lane change control unit 110 finishes the process of the present flowchart. On the other hand, when the virtual interrupt vehicle vm3# has not been set, the virtual vehicle-setting part 112 determines whether or not the lane-change target-position candidate frontward-traveling vehicle m2 during a lane change operation is located at a more rearward position than the frontward traveling vehicle m1 or the virtual vehicle vm1 and at a more frontward position than the vehicle M, that is, whether or not the lane-change target-position candidate frontward-traveling vehicle m2 during a lane change operation is located at a position between the vehicle M and the frontward traveling vehicle m1 or the virtual vehicle vm1 (Step S330).

When the lane-change target-position candidate frontward-traveling vehicle m2 during a lane change operation is not located at a position between the vehicle M and the frontward traveling vehicle m1 or the virtual vehicle vm1, the lane change control unit 110 finishes the process of the present flowchart.

On the other hand, when the lane-change target-position candidate frontward-traveling vehicle m2 during a lane change operation is located at a position between the vehicle M and the frontward traveling vehicle m1 or the virtual vehicle vm1, it is determined whether or not the relative speed Vr between the speed of the lane-change target-position candidate frontward-traveling vehicle m2 and the speed of the vehicle M is equal to or more than zero (Step S332).

When the relative speed Vr is equal to or more than zero, the virtual vehicle-setting part 112 sets a non-setting region NSR at a frontward position of the vehicle M (Step S334).

On the other hand, when the relative speed Vr is neither equal to nor more than zero, or when the non-setting region NSR is set, the virtual vehicle-setting part 112 determines whether or not a virtual vehicle vm1 has already been set (Step S336). When the virtual vehicle vm1 has already been set, the virtual vehicle-setting part 112 erases the set virtual vehicle vm1 (Step 5338) and sets a virtual interrupt vehicle vm2# which virtually simulates the lane-change target-position candidate frontward-traveling vehicle m2 during a lane change operation as a movable body in the detection region DR that excludes the non-setting region NSR (Step S340).

On the other hand, when the virtual vehicle vm1 is not set, the virtual vehicle-setting part 112 skips the process of Step S338 and performs the process of Step 5340 described above. Thereby, the process of the present flowchart is finished.

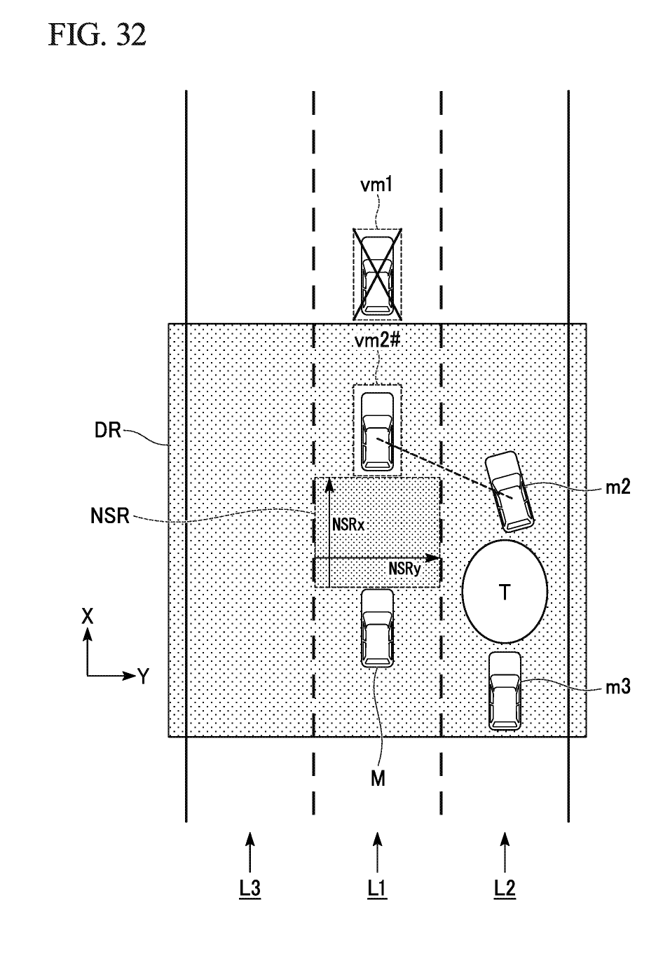

FIG. 32 is a view schematically showing a scene in which the virtual interrupt vehicle vm2# which virtually simulates the lane-change target-position candidate frontward-traveling vehicle m2 is set in the detection region DR at a frontward position of the non-setting region NSR. The example of FIG. 32 represents a situation in which a frontward traveling vehicle m1 is not present in the detection region DR, a lane-change target-position candidate frontward-traveling vehicle m2 and a lane-change target-position candidate rearward-traveling vehicle m3 are present in the detection region DR, and the lane-change target-position candidate frontward-traveling vehicle m2 will perform a lane change from the adjacent lane L2 to the travel lane L1. In the example of FIG. 32, the lane-change target-position candidate frontward-traveling vehicle m2 is located at a position between the virtual vehicle vm1 and the vehicle M, and therefore, the virtual vehicle-setting part 112 sets a virtual interrupt vehicle vm2#. At this time, the virtual vehicle-setting part 112 sets a non-setting region NSR with reference to a front end part of the vehicle M by using the function F as shown in FIG. 31 described above. The virtual vehicle-setting part 112 sets the virtual interrupt vehicle vm2# in a region that excludes the non-setting region NSR.

In such a case, the other vehicle position change estimation part 113 estimates a future position change with respect to the virtual interrupt vehicle vm2# that is set by the virtual vehicle-setting part 112, the lane-change target-position candidate frontward-traveling vehicle m2 that is recognized by the outside recognition unit 104, and the lane-change target-position candidate rearward-traveling vehicle m3 that is recognized by the outside recognition unit 104.

According to the vehicle control apparatus 100, the vehicle control method, and the vehicle control program in the second embodiment described above, when a monitored vehicle that is traveling on the adjacent lane performs a lane change onto the travel lane, a non-setting region NSR is set on the travel lane, and therefore, a virtual vehicle is not set at a position close to the vehicle M. Thereby, even when the monitored vehicle performs a lane change by cutting into the travel lane, the vehicle control apparatus 100 in the second embodiment can realize a gradual transition of a control state. As a result, the vehicle control apparatus 100 in the second embodiment can smoothly control the travel of the vehicle M.

According to the vehicle control apparatus 100, the vehicle control method, and the vehicle control program in the second embodiment, the non-setting region NSR described above is set on the basis of the relative speed Vr between the speed of the vehicle M and the speed of the monitored vehicle, and therefore, it is possible to change the setting position of the virtual vehicle in accordance with the travel state of the vehicle M and the monitored vehicle. As a result, the vehicle control apparatus 100 in the second embodiment can further smoothly control the travel of the vehicle M.

### Third Embodiment

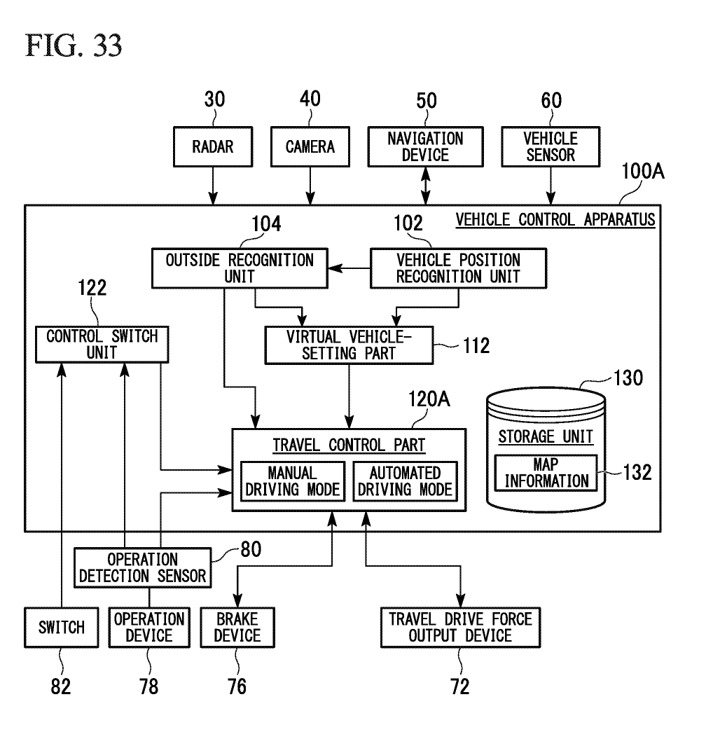

Hereinafter, a third embodiment is described. FIG. 33 is a function configuration view of the vehicle M focusing on a vehicle control apparatus 100A according to a third embodiment. A common reference numeral is given to a function part that is common to the first embodiment, and redundant description of the function part is omitted. The outside recognition unit 104 of the vehicle control apparatus 100A estimates whether or not the peripheral vehicle is performing a lane change (or whether or not the peripheral vehicle will perform a lane change) on the basis of the position history of the peripheral vehicle, the operation state of a direction indicator, and the like, similarly to the first embodiment. When detecting a lane number decrease at a frontward position of the vehicle M on the basis of the position of the vehicle M and the map information 132 that are acquired from the navigation device 50 or information that is input from the finder 20, the radar 30, the camera 40, and the like, the outside recognition unit 104 estimates a lane change of the peripheral vehicle on the basis of the distance or the arrival time to the point of the lane number decrease.

The outside recognition unit 104 is another example of an “estimation part”.

When a peripheral vehicle that is estimated by the outside recognition unit 104 to perform a lane change to the lane on which the vehicle M is traveling is present, the virtual vehicle-setting part 112 sets a virtual vehicle which virtually simulates the peripheral vehicle in a predetermined state. The predetermined state is, for example, a state in which the current speed of the peripheral vehicle is maintained.

Then, a travel control part 120A according to the third embodiment performs a control that maintains an inter-vehicle distance to be constant with respect to a peripheral vehicle that is closer to the vehicle M of a peripheral vehicle which is traveling at a frontward position of the vehicle M and a virtual vehicle which is set at a frontward position of the vehicle M when the driving mode is set to the automated driving mode.

Thereby, the vehicle control apparatus 100A can perform a safer control compared to an apparatus that performs an inter-vehicle distance control only with respect to a vehicle which is actually traveling at a frontward position of the vehicle M.

In the above embodiments, a control method of automated driving in a case of a lane change event is described; however, similarly, a virtual vehicle may be set, and the travel of the vehicle M may be controlled even in a case of other events.

Although embodiments of the invention have been described with reference to the drawings, the present invention is not limited to the embodiments, and a variety of changes and substitutions can be added without departing from the scope of the invention.

### DESCRIPTION OF THE REFERENCE SYMBOLS

20: FINDER

30: RADAR

40: CAMERA

50: NAVIGATION DEVICE

60: VEHICLE SENSOR

72: TRAVEL DRIVE FORCE OUTPUT DEVICE

74: STEERING DEVICE

76: BRAKE DEVICE

78: OPERATION DEVICE

80: OPERATION DETECTION SENSOR

82: SWITCH

100: VEHICLE CONTROL APPARATUS

102: VEHICLE POSITION RECOGNITION UNIT

104: OUTSIDE RECOGNITION UNIT

106: ACTION PLAN GENERATION UNIT

110: LANE CHANGE CONTROL UNIT

111: TARGET POSITION CANDIDATE-SETTING PART

112: VIRTUAL VEHICLE-SETTING PART

113: OTHER VEHICLE POSITION CHANGE ESTIMATION PART

114: CONTROL PLAN GENERATION PART

115: TARGET POSITION DETERMINATION PART

120: TRAVEL CONTROL PART

122: CONTROL SWITCH UNIT

130: STORAGE UNIT

M: VEHICLE

What is claim is:

1. A vehicle control apparatus that is provided on a vehicle, the apparatus comprising:
an estimation part that estimates a lane change by a peripheral vehicle which is traveling around the vehicle;
a virtual vehicle-setting part that sets a virtual vehicle, which virtually simulates the peripheral vehicle as a target of the estimation, on a lane of a lane change destination of the peripheral vehicle when the lane change by the peripheral vehicle is estimated by the estimation part;
a control plan generation part that generates a control plan of the vehicle based on the virtual vehicle which is set by the virtual vehicle-setting part; and
a travel control part that controls acceleration, deceleration, or steering of the vehicle based on the control plan which is generated by the control plan generation part.

2. The vehicle control apparatus according to claim 1,
wherein the virtual vehicle-setting part sets a state of the virtual vehicle based on information relating to a speed of the peripheral vehicle as the target of the estimation when the lane change by the peripheral vehicle is estimated by the estimation part.

3. The vehicle control apparatus according to claim 1,
wherein the virtual vehicle-setting part provides a non-setting region, in which the virtual vehicle is not set, at a frontward position from a position of the vehicle when the lane of the lane change destination of the peripheral vehicle when the lane change by the peripheral vehicle is estimated by the estimation part is a lane on which the vehicle is traveling.

4. The vehicle control apparatus according to claim 3,
wherein the non-setting region is provided based on a relative speed between a speed of the vehicle and a speed of the peripheral vehicle as the target of the estimation of the lane change.

5. The vehicle control apparatus according to claim 1,
wherein the virtual vehicle-setting part sets the virtual vehicle on a lane on which the vehicle is traveling when a lane change by the peripheral vehicle with respect to a space between the vehicle and a frontward traveling vehicle that is traveling at a frontward position of the vehicle is estimated by the estimation part, and
the control plan generation part generates the control plan of the vehicle based on the virtual vehicle which is set by the virtual vehicle-setting part in place of the frontward traveling vehicle.

6. The vehicle control apparatus according to claim 1,
wherein the estimation part estimates that the peripheral vehicle which is traveling around the vehicle performs a lane change when detecting a decrease of the number of lanes at a frontward position of the vehicle.

7. The vehicle control apparatus according to claim 6,
wherein the estimation part detects a decrease of the number of lanes at a frontward position of the vehicle with reference to map information by using a position of the vehicle.

8. The vehicle control apparatus according to claim 6,
wherein the estimation part estimates a timing when the peripheral vehicle which is traveling around the vehicle performs a lane change based on a distance or an arrival time to a point where the number of lanes is decreased from the vehicle or the peripheral vehicle when detecting a decrease of the number of lanes at a frontward position of the vehicle.

9. A vehicle control apparatus that is provided on a vehicle, the apparatus comprising:
an estimation part that estimates a lane change by a peripheral vehicle which is traveling around the vehicle when detecting a decrease of the number of lanes at a frontward position of the vehicle;
a virtual vehicle-setting part that sets a virtual vehicle, which virtually simulates the peripheral vehicle as a target of the estimation, on a lane of a lane change destination of the peripheral vehicle when the lane change by the peripheral vehicle is estimated by the estimation part; and
a travel control part that controls acceleration, deceleration, or steering of the vehicle based on the virtual vehicle which is set by the virtual vehicle-setting part.

10. A vehicle control method, by way of a computer that is provided on a vehicle, comprising:
estimating a lane change by a peripheral vehicle which is traveling around the vehicle;
setting a virtual vehicle, which virtually simulates the peripheral vehicle as a target of the estimation, on a lane of a lane change destination of the peripheral vehicle when the lane change by the peripheral vehicle is estimated;
generating a control plan of the vehicle based on the set virtual vehicle; and
controlling acceleration, deceleration, or steering of the vehicle based on the generated control plan.

11. A vehicle control program which causes a computer that is provided on a vehicle to:
estimate a lane change by a peripheral vehicle which is traveling around the vehicle;
set a virtual vehicle, which virtually simulates the peripheral vehicle as a target of the estimation, on a lane of a lane change destination of the peripheral vehicle when the lane change by the peripheral vehicle is estimated;
generate a control plan of the vehicle based on the set virtual vehicle; and
control acceleration, deceleration, or steering of the vehicle based on the generated control plan.
